(19) United States
(12) Patent Application Publication
(10) Pub. No.: US 2025/0350929 A1
(43) Pub. Date: Nov. 13, 2025

(54) APPARATUS AND METHOD FOR SIGNALING AI/ML FUNCTIONALITY

(71) Applicant: Lenovo (Singapore) Pte Ltd, Singapore (SG)

(72) Inventors: Tapisha Soni, Munich (DE); Joachim Löhr, Wiesbaden (DE); Vahid Pourahmadi, Munich (DE)

(73) Assignee: Lenovo (Singapore) Pte Ltd, Singapore (SG)

(21) Appl. No.: 18/659,568

(22) Filed: May 9, 2024

(51) Int. Cl. H04W 8/24

(52) U.S. Cl. CPC H04W 8/24

(57) ABSTRACT

Various aspects of the present disclosure relate to an apparatus and method for signaling artificial intelligence (AI)/machine learning (ML) functionality. A first request message for capability information associated with AI can be received. A first response message comprising the capability information can be transmitted in response to the received first request message, where the capability information indicates one or more AI functionalities supported by a UE. A second request message can be received based at least in part on the transmitted first response message, where the second request message includes at least one configuration for AI. A second response message can be transmitted in response to the received second request message, where the second response message includes feedback that indicates whether the at least one AI functionality supported by the UE is applicable for the at least one configuration.

### CROSS-REFERENCE TO RELATED APPLICATIONS

This application is related to an application entitled, “Apparatus and method for communicating AI information,” Lenovo docket number SMM920240068-US-NP, filed on even date herewith, commonly assigned to the assignee of the present application, and which is hereby incorporated by reference.

### TECHNICAL FIELD

The present disclosure relates to wireless communications, and more specifically to an apparatus and method for signaling artificial intelligence (AI)/machine learning (ML) functionality.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources, such as time resources (e.g., symbols, slots, subframes, frames, or the like) and/or frequency resources (e.g., subcarriers, carriers, or the like), of the wireless communication system. Additionally, the wireless communications system may support wireless communications across various radio access technologies including third-generation (3G) radio access technology, fourth-generation (4G) radio access technology, fifth-generation (5G) radio access technology, among other suitable radio access technologies beyond 5G (e.g., sixth-generation (6G)).

### SUMMARY

Some implementations of the method and apparatuses described herein can provide for signaling AI/ML functionality. In at least one embodiment, a first request message for capability information associated with artificial intelligence (AI) can be received. A first response message comprising the capability information can be transmitted in response to the received first request message, where the capability information indicates one or more AI functionalities supported by a UE. A second request message can be received based at least in part on the transmitted first response message, where the second request message includes at least one configuration for AI. A second response message can be transmitted in response to the received second request message, where the second response message includes feedback that indicates whether the at least one AI functionality supported by the UE is applicable for the at least one configuration.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 illustrates an example of a wireless communications system in accordance with aspects of the present disclosure.

FIG. 2 is an example illustration of AI/ML framework in accordance with aspects of the present disclosure.

FIG. 3 is an example illustration of a first one-sided model case in accordance with aspects of the present disclosure.

FIG. 4 is an example illustration of a second one-sided model case in accordance with aspects of the present disclosure.

FIG. 5 is an example illustration of a UE capability framework for AI/ML functionality signal flow diagram in accordance with aspects of the present disclosure.

FIGS. 6A-6D are example illustrations of a UE-new radio (NR)-Capability information element (IE) according to aspects of the present disclosure.

FIG. 7 is an example illustration of an AI/ML applicability reporting framework signal flow diagram for AI/ML functionality in accordance with aspects of the present disclosure.

FIG. 8 is an example illustration of another implementation of an AI/ML applicability reporting framework signal flow diagram for AI/ML functionality in accordance with aspects of the present disclosure.

FIG. 9 is an example illustration of a signal flow diagram for reporting of AI/ML functionality status in accordance with aspects of the present disclosure.

FIG. 10 is an example illustration of a signal flow diagram for reporting of AI/ML functionality status in accordance with aspects of the present disclosure.

FIGS. 11A-11E are example illustrations of a UEAssistanceInformation IE in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a network equipment in accordance with aspects of the present disclosure.

FIG. 15 illustrate a flowchart of method in accordance with aspects of the present disclosure.

FIG. 16 illustrates a flowchart of a method in accordance with aspects of the present disclosure.

FIG. 17 illustrates a flowchart of a method in accordance with aspects of the present disclosure.

FIG. 18 illustrates a flowchart of a method in accordance with aspects of the present disclosure.

### DETAILED DESCRIPTION

AI/ML models for a given use case can be tailored toward and applicable to specific scenarios, configurations, locations, and/or deployments, among other factors. After training the models, there can be multiple models at a Node A-side (e.g., a UE), associated with different Node Bs (e.g., gNBs), and multiple models (at the Node B-side) associated with different Node As. Given multiple models for a single functionality, some of which may be scenario/cell/configuration/condition specific, there a mechanism for Node A/Node B could be used to select the appropriate model during the inference phase. It can be assumed the network has a certain level of control to ensure efficient management (selection, activation, deactivation, switching) of AI/ML models/functionality for one-sided models (e.g. UE-sided). A suitable model can or should be selected for the current Node A and Node B state/configuration, which can be defined by the additional conditions of Node A and Node B. There can be a challenge of coordinating between Node A and Node B to ensure that a suitable model for AI/ML functionality can be selected while ensuring consistent performance. At least some embodiments can address this challenge.

Different signaling procedures of at least some embodiments can address the above-described challenge. The signaling procedures can provide support for the exchange of information among different involved Nodes (e.g., UE and gNB) to allow an appropriate AI/ML model selection for AI/ML functionality. Followed by the response from the UE, the gNB can configure the UE for the supported and applicable AI/ML functionality. A node, e.g. UE, transmits the current/updated status (e.g., ACK/NACK) of its supported and applicable AI/ML functionality/model that it reported as its capability (UE capability framework) to a second node, e.g., gNB. This can allow the UE to report updates on applicable UE-side model(s), where the applicable models may be a subset of all supported models. These signaling mechanisms may not be limited to one-sided UE models, and they can be extended for one-sided network (NW) models, as well as for two-sided models.

In some aspects, in the functionality-based life cycle management (LCM) procedure, one potential solution could be that the first node (e.g., UE) may somehow only report to the second node (e.g., gNB) about the AI/ML models/functionalities in general. However, the second node may not be aware of the availability of the potential AI/ML models applicable for the current scenario or configuration of the second node. In this case, the second node (gNB) may configure the first node for the AI/ML functionality without knowing if there exists an applicable model for the functionality for the second node. The first node may autonomously select an AI/ML model for the functionality or fallback to legacy operation without coordinating with the second node about the status of the AI/ML model/functionality. Alternatively, the second node may not be informed about the functionality suppported by the first node and the AI/ML functionality LCM is completely controlled by the first node. This leaves no room for the NW to manage or assist the first node in AI/ML LCM procedure. At least some embodiments can address this issue.

According to a possible example embodiment, the UE capability framework can be extended to report the supported AI/ML functionalities by the UE. The UE can report all its supported AI/ML functionalities upon receiving a request from the NW.

According to a possible example embodiment, a mechanism can enable a request/response of the applicability of a specific AI/ML functionality. In an example, a first node, such as a gNB, sends a request, AI/ML applicability request, to the second node, such as a UE, to inquire about the applicability of the AI/ML functionality/model. The first node sends the AI/ML applicability request which contains some configuration or indication required to determine applicability of the functionality meaning determining a suitable model for an AI/ML functionality for the configuration. In response, the second node, e.g., UE, sends a response, AI/ML applicability response, reassuring the support i.e., applicability of an AI/ML functionality. The NW can configure the UE based on the response.

According to a possible example embodiment, the UE reports its status on AI/ML functionality to the NW. If any UE-side conditions are changed or the model is updated, the UE sends a status report to the NW. It may contain ACK/NACK for the functionality along with additional assistance information.

Aspects of the present disclosure are described in the context of a wireless communications system.

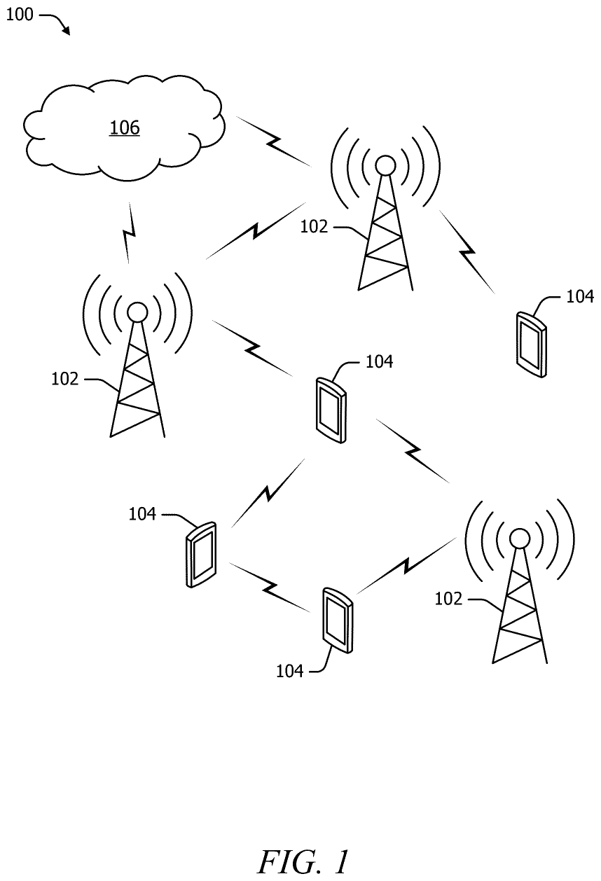

FIG. 1 illustrates an example of a wireless communications system 100 in accordance with aspects of the present disclosure. The wireless communications system 100 may include one or more NE 102, one or more UE 104, and a NW 106. The wireless communications system 100 may support various radio access technologies. In some implementations, the wireless communications system 100 may be a fourth-generation (4G) NW, such as a long-term evolution (LTE) NW or an LTE-Advanced (LTE-A) NW. In some other implementations, the wireless communications system 100 may be a new radio (NR) NW, such as a 5G NW, a 5G-Advanced (5G-A) NW, or a 5G ultrawideband (5G-UWB) NW. In other implementations, the wireless communications system 100 may be one of, or a combination of, a 4G NW, a 5G NW, a Third Generation Partnership Project (3GPP)-based NW, one or more of a future generation NW (6G, etc.), and/or one or more of any other suitable radio access technology, wireless access technology, and/or wired access technology, including Institute of Electrical and Electronics Engineers (IEEE) 802.11 (Wi-Fi), IEEE 802.16 (WiMAX), IEEE 802.20, a Wireless Local Area Networks (WLAN), a satellite communications NW, high-altitude platform NW, the Internet, and/or other communications NWs. The wireless communications system 100 may support radio access technologies beyond 5G, for example, 6G. Additionally, the wireless communications system 100 may support various multiple access technologies, such as time division multiple access (TDMA), frequency division multiple access (FDMA), code division multiple access (CDMA), Orthogonal Frequency Division Multiple Access (OFDMA), etc.

The one or more NE 102 may be dispersed throughout a geographic region to form the wireless communications system 100. One or more of the NE 102 described herein may be or include or may be referred to as a NW node, a base station, a NW element, a NW function, a NW entity, a radio access NW (RAN), a NodeB, an eNodeB (eNB), a next-generation NodeB (gNB), an access point, a transmission-reception point (TRP), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial NW (NTN). In some implementations, different geographic coverage areas associated with the same or different radio access technologies may overlap, but the different geographic coverage areas may be associated with different NEs 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the NW 106, or with another NE 102, or both. For example, an NE 102 may interface with another NE 102 or the NW 106 through one or more backhaul links (e.g., S1, N2, N2, or NW interface). In some implementations, the NE 102 may communicate with each other directly. In some other implementations, the NE 102 may communicate with each other or indirectly (e.g., via the NW 106). In some implementations, one or more NE 102 may include subcomponents, such as an access NW entity, which may be an example of an access node controller (ANC). An ANC may communicate with the one or more UEs 104 through one or more other access NW transmission entities, which may be referred to as a radio heads, smart radio heads, or TRPs.

The NW 106 may support user authentication, access authorization, tracking, connectivity, and other access, routing, or mobility functions. The NW 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external NWs (e.g., a serving gateway (S-GW), a packet data NW (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the NW 106.

The NW 106 may communicate with a packet data NW over one or more backhaul links (e.g., via an S1, N2, N2, or another NW interface). The packet data NW may include an application server. In some implementations, one or more UEs 104 may communicate with the application server. A UE 104 may establish a session (e.g., a protocol data unit (PDU) session, or the like) with the NW 106 via an NE 102. The NW 106 may route traffic (e.g., control information, data, and the like) between the UE 104 and the application server using the established session (e.g., the established PDU session). The PDU session may be an example of a logical connection between the UE 104 and the NW 106 (e.g., one or more NW functions of the NW 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data, etc.). For example, communications traffic can include user data, control information, and other communications traffic. The control information can be used for establishing and controlling communications that transmit and receive the user data, such as in packets, in physical shared channels, in data regions of subframes, and in other communications.

In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A list of at least some abbreviations above and at least some other abbreviations relevant to at least some embodiments of the present disclosure is provided at the end of this detailed description for ease of reference.

Embodiments can provide for an apparatus and method for signaling AI/ML functionality. At least some embodiments can provide for signaling for one-sided AI/ML framework.

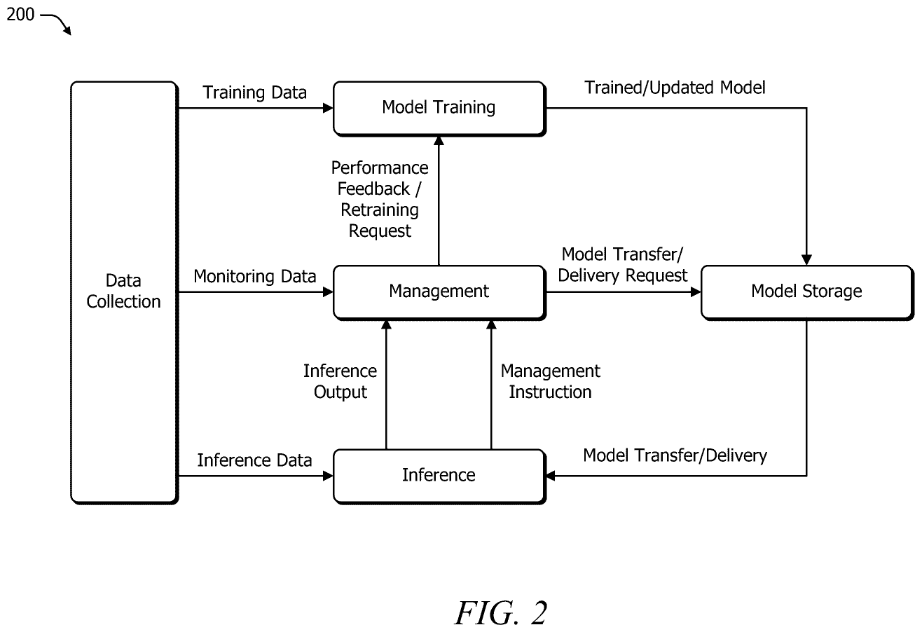

FIG. 2 is an example illustration of AI/ML framework 200 in accordance with aspects of the present disclosure. The AI/ML framework can include Data Collection, Model Training, Management, Inference, and Model Storage. Data Collection is a function that provides input data to the Model Training, Management, and Inference functions. Training Data is data needed as input for the AI/ML Model Training function. Monitoring Data is data needed as input for the Management of AI/ML models or AI/ML functionalities. Inference Data is data needed as input for the AI/ML Inference function.

Model Training is a function that performs AI/ML model training, validation, and testing which may generate model performance metrics that can be used as part of the model testing procedure. The Model Training function is also responsible for data preparation (e.g., data pre-processing and cleaning, formatting, and transformation) based on Training Data delivered by a Data Collection function if required. Management is a function that oversees the operation (e.g., selection/(de)activation/switching/fallback) and monitoring (e.g., performance) of AI/ML models or AI/ML functionalities. This function is also responsible for making decisions to ensure the proper inference operation based on data received from the Data Collection function and the Inference function. Management Instruction is the information needed as input to manage the Inference function. Concerning information may include selection/(de)activation/switching of AI/ML models or AI/ML-based functionalities, fallback to non-AI/ML operation (i.e., not relying on inference process), etc. Model transfer/delivery request is used to request model(s) to the Model Storage function. Performance feedback/retraining request is the information needed as input for the Model Training function, e.g., for model (re)training or updating purposes. Inference is a function that provides outputs from the process of applying AI/ML models or AI/ML functionalities, using the data that is provided by the Data Collection function (i.e., Inference Data) as input. For example, inference can be the process of using a trained AI model to make new predictions on new data. The Inference function is also responsible for data preparation (e.g., data pre-processing and cleaning, formatting, and transformation) based on Inference Data delivered by a Data Collection function, if required. Inference Output is data used by the Management function to monitor the performance of AI/ML models or AI/ML functionalities. Model Storage is a function responsible for storing trained/updated models that can be used to perform the Inference function.

Life cycle management (LCM) of AI/ML model/functionality is studied in Release 18 AI/ML for air interface study item. Two flavors of AI/ML LCM are considered: Model-ID-based LCM and functionality-based LCM.

In functionality-based LCM, the NW indicates activation/deactivation/fallback/switching of AI/ML functionality via 3GPP signaling (e.g., RRC, MAC-CE, DCI). Models may not be identified at the NW, and a UE may perform model-level LCM. Whether and how much awareness/interaction NW should have about model-level LCM may require further study. For functionality identification, there may be either one or more than one functionality defined within an AI/ML-enabled feature, where the AI/ML-enabled feature can refer to a feature where AI/ML may be used. It is noted that a UE may have one AI/ML model for the functionality, or UE may have multiple AI/ML models for the functionality.

For AI/ML functionality identification and functionality-based LCM of UE-side models and/or UE-part of two-sided models, functionality refers to an AI/ML-enabled feature/feature group (FG) enabled by configuration(s), where configuration(s) is(are) supported based on conditions indicated by UE capability. Correspondingly, functionality-based LCM operates based on at least one configuration of AI/ML-enabled feature/FG or specific configurations of an AI/ML-enabled Feature/FG.

After functionality identification, necessity, mechanisms for UE to report updates on applicable functionality(es) among functionality(es) are studied, where the applicable functionalities may be a subset of all functionalities. Applicable functionalities can be reported by the UE.

In model-ID-based LCM, models are identified at the NW, and the NW/UE may activate/deactivate/select/switch individual AI/ML models via model ID.

For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled feature/FG and additional conditions (e.g., scenarios, sites, and datasets) as determined/identified between UE-side and NW-side.

After model identification, necessity, mechanisms for UE to report updates on applicable UE part/UE-side model(s) are studied, where the applicable models may be a subset of all identified models. Applicable models can be reported by the UE.

How to handle the impact of UE's internal conditions such as memory, battery, and other hardware limitations on functionality/model operations and AI/ML-enabled features can be studied. It is noted that this does not preclude any existing solutions.

For functionality/model-ID-based LCM, once functionalities/models are identified, the same or similar procedures may be used for their activation, deactivation, switching, fallback, and monitoring.

A Model ID, if needed, can be used in a functionality (defined in functionality-based LCM) for LCM operations.

Different use cases of AI/ML functionalities/models can include CSI feedback enhancement, beam management, positioning accuracy, and/or other use cases.

In at least some embodiments, the following definitions can be used: AI/ML-enabled Feature: refers to a Feature where AI/ML may be used. AI/ML Functionality: Functionality refers to an AI/ML-enabled Feature/FG enabled by configuration(s), where configuration(s) is(are) supported based on conditions indicated by UE. NW-side (AI/ML) model: An AI/ML Model whose inference is performed entirely at the NW. UE-side (AI/ML) model: An AI/ML Model whose inference is performed entirely at the UE. Functionality identification: A process/method of identifying an AI/ML functionality for the common understanding between the NW and the UE. Where AI/ML functionality resides depends on the specific use cases and sub use cases. Supported functionalities: As a result of functionality identification, the common understanding of functionalities supported in general is developed between the NW and the UE. The functionalities can be said to be identified or supported. Applicable functionalities: Applicable functionalities can be a subset of supported functionalities. Condition: Condition can be defined as the criteria comprising details that are specific to the scenario/site/configuration/context for AI/ML functionality. E.g., an AI/ML model for a functionality can be trained for or associated with a ‘condition’, thus, this functionality can be said to be applicable functionality under this ‘condition’. Additional conditions: The conditions not included in the above-defined “Condition”, that may vary for different scenarios, sites, datasets, etc. are defined as additional conditions. E.g., UE internal conditions such as battery, memory, or other hardware limitation. There may be UE-side conditions and NW-side conditions. Additional conditions of one node (e.g., UE-side additional conditions) may contain private information that is not known to the other node (e.g., gNB) and may not be revealed to the other node (gNB). UE-state: A state of the UE is defined as the UE-state depending on specific UE-side internal/additional conditions and scenario. gNB-state: A state of the gNB is defined as the NW-state depending on specific NW-side additional conditions, scenario, and configurations. Scenario: A scenario can be defined as a deployment scenario categorized based on different factors such as channel models (heavy LOS/NLOS conditions, UMi, UMa, InH), outdoor/indoor UE distributions, carrier frequencies, UE speeds, antenna spacings, etc. For example, NW-defined scenarios can be scenarios with NW-defined dataset categorization. UE-defined scenarios can be scenarios with UE-defined dataset categorization. Configuration: The set of configurations can be considered, focusing on one of the following aspects: bandwidth, UE speed, antenna port layouts, numerology, etc.

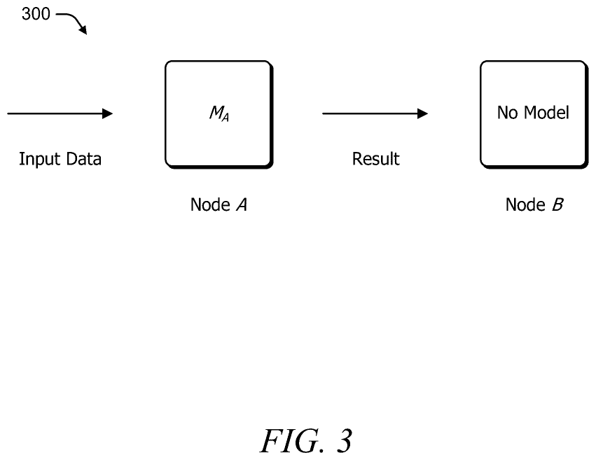

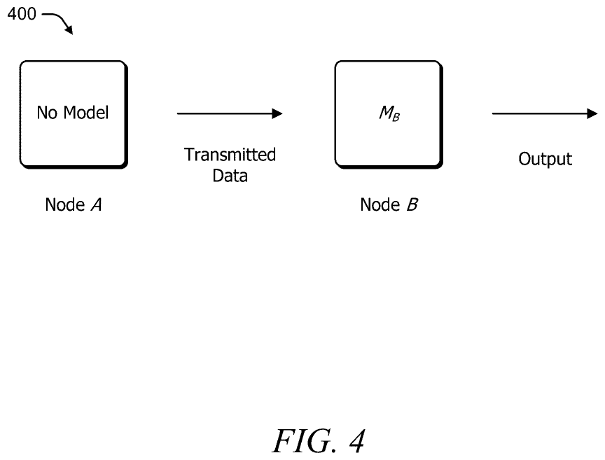

FIG. 3 is an example illustration of a first one-sided model case 300 in accordance with aspects of the present disclosure. The first one-sided model case 300 can be for a Node-A side model. FIG. 4 is an example illustration of a second one-sided model case 400 in accordance with aspects of the present disclosure. The second one-sided model case 400 can be for a Node-B side model. The one-sided model cases 300 and 400 are high-level representations of two cases of one-sided models for use cases such as beam management, CSI prediction, radio resource management (RRM) measurement prediction, radio link failure prediction, handover failure prediction, positioning, etc.

Embodiments can focus on one-sided models, in which the AI/ML model is located either at Node A (e.g., UE) or Node B (e.g., gNB) referred to here as M_{A} (model located at Node A) and M_{B} (model located at Node B), respectively. It is noted that the one-sided models are for the sake of illustrations, and Node A/Node B can be either a gBN or a UE.

AI/ML models for a given use case may be tailored toward and applicable to specific scenarios, configurations, locations, and/or deployments, among other factors. In this regard, it is acknowledged that AI/ML models may undergo updates, such as model changes, as an inherent part of their development. After training the models, there can be multiple models (at Node A-side), associated with different Node Bs, and multiple models (at Node B-side) associated with different Node As. Given multiple models for a single functionality, some of which may be scenario or cell-specific, there can be a mechanism for Node A/Node B to select the appropriate model during the inference phase. A suitable model can be selected for the current Node A and Node B state, which can be defined by the additional conditions of Node A and Node B.

For one-sided AI/ML models, e.g., UE-sided models, it can be assumed that the NW has a certain level of control to ensure efficient management (selection, activation, deactivation, switching) of AI/ML models/functionality. This can bring a challenge of coordinating between Node A and Node B to ensure that a suitable model for AI/ML functionality can be selected while ensuring consistent performance. Several embodiments disclose signaling procedures that provide support for the exchange of information among different involved Nodes (e.g., UE and gNB) to allow an appropriate AI/ML model selection for AI/ML functionality. These signaling mechanisms and messages (request/response/report) are not limited to one-sided UE models, and they can be extended for one-sided NW models as well as for two-sided models.

The following abbreviations are considered relevant to the present disclosure.

Table of Abbreviations

| | |
|---|---|
| 3GPP | 3rd generation partnership project |
| 5G | fifth generation |
| 5GS | 5G System |
| 5QI | 5G QoS identifier |
| AI | artificial intelligence |
| AS | access stratum |
| DL | downlink |
| FG | feature group |
| IE | information element |
| KPI | key performance indicator |
| LCG | logical channel group |
| LCM | life cycle management |
| ML | machine learning |
| NW | network |
| QoE | quality of experience |
| QoS | quality of service |
| QCI | QoS class identifier |
| RAN | radio access network |
| RRC | radio resource control |
| RRM | radio resource management |
| SDAP | service data adaptation protocol |
| SIB | system information broadcast |
| TS | technical specification |
| UE | user equipment |
| UL | uplink |

In a functionality-based life cycle management (LCM) procedure, the first node (e.g., UE) may only report to the second node (e.g., gNB) about the AI/ML models/functionalities. However, the second node may not be aware of the availability of the potential AI/ML models at the first node applicable for the current scenario or configuration of the second node. The second node (gNB) configures the first node for the AI/ML functionality without knowing if there exists an applicable model at the first node for the functionality for the second node. The first node may autonomously select an AI/ML model for the functionality or fallback to legacy without coordinating with the second node.

Embodiments can consider functionality-based LCM for NW-sided AI/ML models and UE-sided AI/ML models. It can be assumed that the data collection for training different AI/ML models has already been performed and the models have been trained at the respective entities. The statistics of training data samples can depend on the type (e.g., NW vendor, chipset vendor) of the two nodes (e.g., Node A and Node B) that are involved during data collection. For a single functionality, multiple models may exist at Node A (e.g., UE) for Node B (e.g., gNB) referring to different configurations, scenarios, and/or NW/UE conditions.

According to possible embodiments, a UE can report its AI/ML capability to NW.

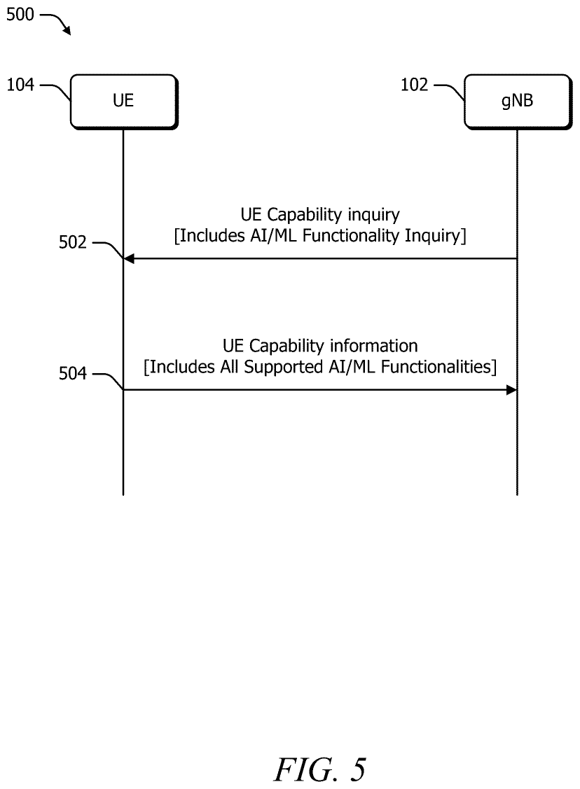

FIG. 5 is an example illustration of a UE capability framework for AI/ML functionality signal flow diagram 500 in accordance with aspects of the present disclosure. The signal flow diagram 500 includes a UE 104 and a NE 102, such as a gNB. At 502, the gNB 102 can send a UE capability inquiry that can include an AI/ML functionality inquiry. At 504, the UE 104 can send UE capability information that can include at least some or all supported AI/ML functionalities.

According to a possible embodiment, a first node requests a second node to provide information based on which the first node is aware of the AI/ML functionality supported by the second node for the first node. According to one implementation of the embodiment, the first node, e.g. gNB, explicitly requests a second node, e.g. UE, to provide some indication of the specific AI/ML functionality, e.g. beam prediction, positioning, etc. that the second node, e.g. UE, supports for the first node, e.g. gNB.

In order to become aware of the AI/ML functionality, supported by the UE for a specific gNB, the gNB can explicitly request the UE to provide such information. This request can also contain some identifier (e.g., NW vendor information) that represents the type of the first node, e.g., gNB. In order to ensure the transparency between the involved nodes (e.g. Node A (UE)/Node B(gNB)) and not reveal the exact device type (e.g. detailed chipset information, detailed gNB vendor information, etc.) some identifiers (e.g. Proxy-ID(s)) can be assigned to the involved nodes, e.g. either pre-assigned or allocated during the LCM phases (for example during the model training phase).

In one implementation, the gNB requests the UE to provide the supported functionality as a UE capability report. Upon reception of a corresponding UECapabilityEnquiry RRC message containing the AI/ML functionality request, the UE reports all the AI/ML functionalities that it supports in general via a UECapabilityInformation RRC message. The existing UE capability framework can be extended with additional IE for AI/ML-relevant UE capability. In another implementation, the supported AI/ML functionalities can be inquired using a new RRC signaling. It is noted that the terms enquire and inquire are considered synonymous. Alternatively, this request for AI/ML functionality can be sent using a new MAC CE or using DCI. Thus, the response message from the UE containing the supported AI/ML functionalities can be sent via new RRC signaling or via a new MAC CE.

A supported AI/ML functionality can be referred to as the AI/ML functionality for which a node contains one or more AI/ML models, while these models may be generalized or cell-specific. This stage may not ensure that the UE has an AI/ML model that can be activated for the current gNB/UE state or the current scenario.

The gNB may need the capabilities for AI/ML features and it can use the featureSets in the UE-NR-Capability to determine the NR UE capabilities for the supported AI/ML features. It may be required to extend the UE feature list for each AI/ML relevant feature/functionality.

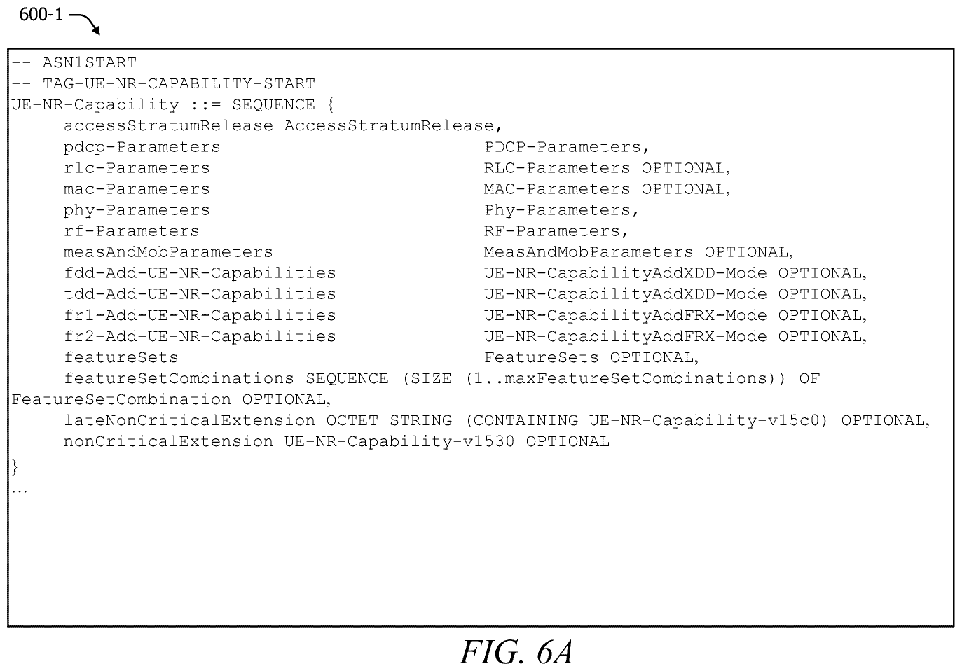

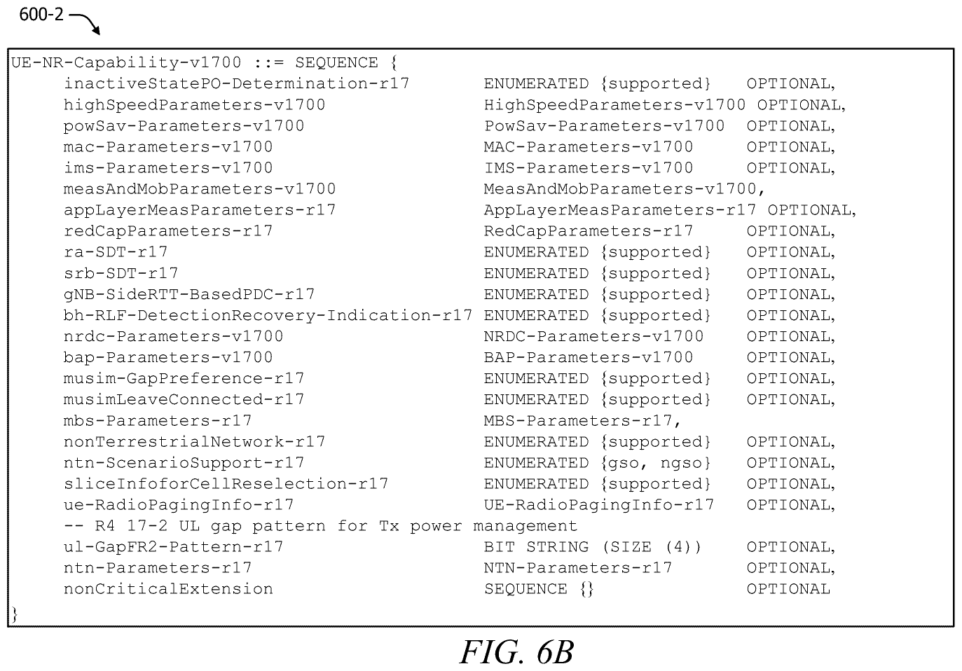

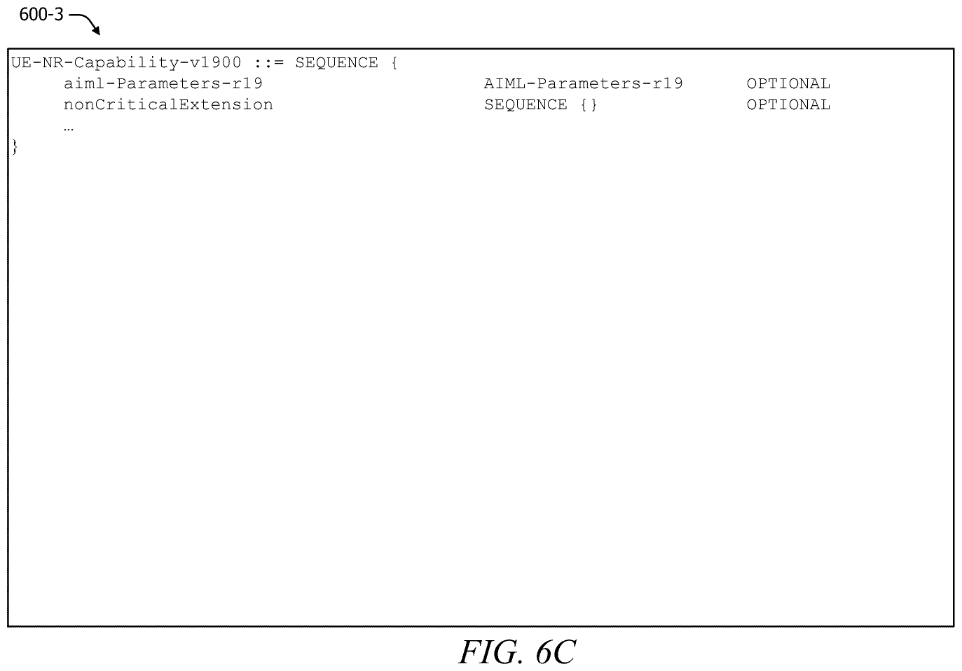

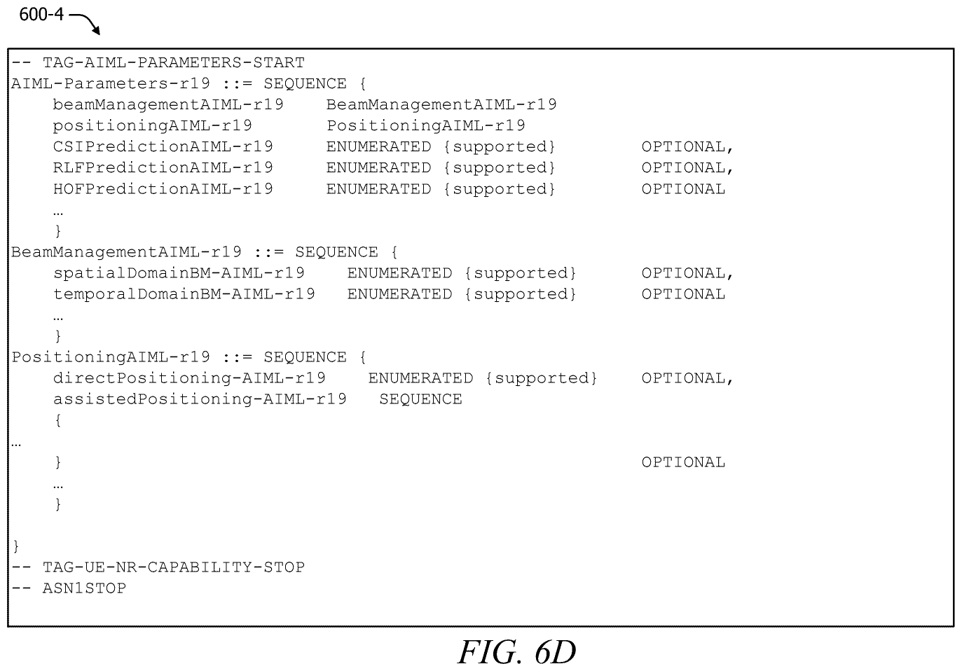

FIGS. 6A-6D are example illustrations of a UE-NR-Capability IE 600 according to aspects of the present disclosure. The IE UE-NR-Capability can be used to convey the NR UE Radio Access Capability Parameters, as illustrated in 600-1 and 600-2 and as described in TS 38.306. A UE capability inquiry, which can be an AI/ML IE capability inquiry, is illustrated in 600-3. An AIML-Parameters IE, such as an AI/ML IE, is illustrated in 600-4. The AIML-Parameters IE can be AI/ML specific parameters and can indicate the supported AI/ML functionalities in a UE capability report.

For an applicable AI/ML framework, an applicable AI/ML functionality can be referred to as the AI/ML functionality for which a node contains one or more AI/ML models that are suitable/applicable for the current gNB-state, UE state, and the scenario. Applicability of an AI/ML functionality can be defined as the confirmation of supported AI/ML functionality by a second node for the first node, for the current state of both nodes. In other words, functionality can be said to be applicable functionality when it is applicable under the current condition, context scenario, configuration, location, and/or deployment, among other factors).

According to a possible embodiment, a handshake between the two nodes takes place to enable coordination on the supported AI/ML functionality for the current state of node A and node B. The first node requests a second node to provide confirmation of its specific (supported) AI/ML functionality based on which the first node is aware of the AI/ML functionality applicable by the second node for the first node. According to one implementation of the embodiment, the first node, e.g. gNB, explicitly requests a second node, e.g. UE, to provide some indication of the applicability of its AI/ML functionality that was sent in the capability report, that the second node, e.g. UE, has a model for specific AI/ML functionality for the first node, e.g. gNB. A new AI/ML functionality framework for applicability is introduced, in which the first node, e.g., the gNB, sends the AI/ML applicability request for the supported AI/ML functionality, to the second node, e.g., the UE.

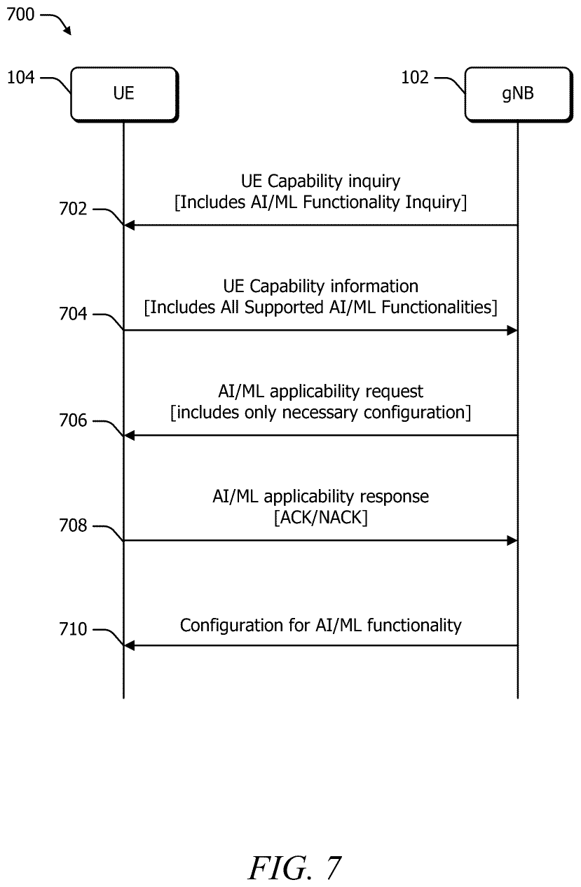

FIG. 7 is an example illustration of an AI/ML applicability reporting framework signal flow diagram 700 for AI/ML functionality in accordance with aspects of the present disclosure. The signal flow diagram 700 includes a UE 104 and a NE 102, such as a gNB. At 702, the gNB 102 can send a UE capability inquiry that can include an AI/ML functionality inquiry. At 704, the UE 104 can send UE capability information that can include at least some or all supported AI/ML functionalities. At 706, the gNB 102 can send an AI/ML applicability request, which may include only the necessary configuration or may include additional configuration(s). At 708, the UE 104 can send an AI/ML applicability response that can include an ACK/NACK. At 710, the gNB can send a configuration for AI/ML functionality, which can be performed in at least some or all embodiments.

For example, the AI/ML applicability request may contain only the necessary configuration for the supported AI/ML functionality. In a possible example, considering AI/ML functionality for beam management: set B is the measured set of beams, and set A is the predicted set of beams; the configuration of set A and set B can be sufficient for the UE to determine whether an AI/ML model for the requested AI/ML functionality for the current configuration of set A/set B exists, in other words whether beam management functionality is applicable for the current configuration. In some cases, a configuration of set B alone is sufficient to determine the suitable A/ML model for beam management. Upon reception of the applicability request, the second node, e.g. UE, determines its AI/ML models and reports (e.g., ACK/NACK) whether a suitable AI/ML model/applicable functionality for the requested configuration is available for the gNB via an AI/ML applicability response message. Followed by the applicability response from the UE, the gNB can configure the UE for the supported and applicable AI/ML functionality via RRC configuration. The assumption is that this remaining configuration will not impact the UE's decision to determine the applicability of the AI/ML functionality. Alternatively, the NW may send one or more configurations for a functionality and some switching rule. Depending on which the UE may select the AI/ML model for one of the configurations and switch to one of the other configurations based on the switching rule provided by the NW. In general, determination of the applicability of functionalities can be done by the UE or the NW, depending on the type of AI/ML model (UE-sided or NW-sided) and depending on which node performs the management (selection, switching, fallback etc.) of the AI/ML model.

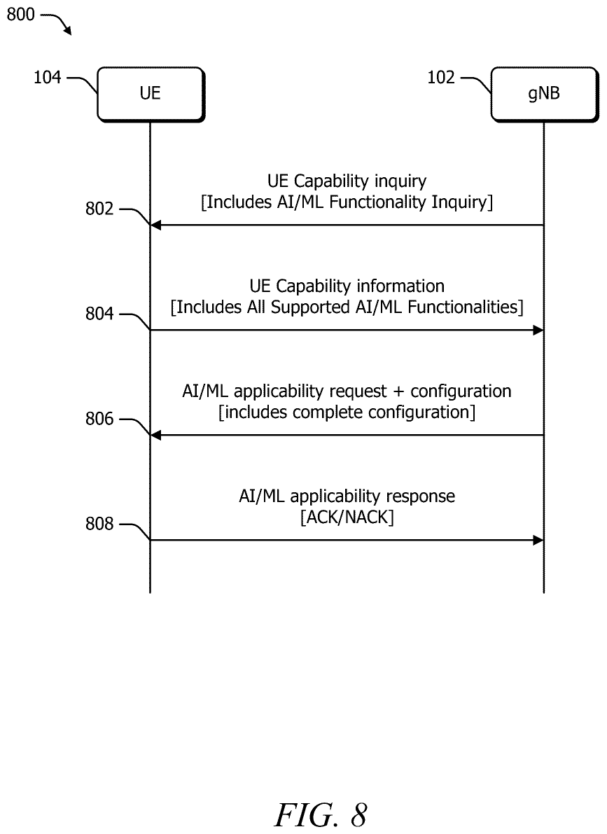

FIG. 8 is an example illustration of another implementation of an AI/ML applicability reporting framework signal flow diagram 800 for AI/ML functionality in accordance with aspects of the present disclosure. The signal flow diagram 800 includes a UE 104 and a NE 102, such as a gNB. At 802, the gNB 102 can send a UE capability inquiry that can include an AI/ML functionality inquiry. At 804, the UE 104 can send UE capability information that can include at least some or all supported AI/ML functionalities. At 806, the gNB 102 can send an AI/ML applicability request, which may include a complete configuration. At 808, the UE 104 can send an AI/ML applicability response that can include an ACK/NACK.

For example, the first node, e.g., the gNB, sends the AI/ML applicability request, which includes complete configuration for the supported AI/ML functionality, to the second node, e.g., the UE. To which, the second node, e.g. UE, responds with an AI/ML applicability response message indicating if it contains a suitable model.

The applicability request from the gNB can be transmitted via a new RRC signaling mechanism. Alternatively, a new MAC CE can be introduced for requesting this AI/ML applicability for a specific supported functionality from the UE. This applicability request may additionally contain some identifier of type (e.g. NW vendor) of the node (e.g. gNB), if the identifier was not sent as part of the capability request. Identifiers of additional conditions called as associated ID(s) may also be included in the applicability request. For the NW-sided models or two-sided models, the gNB sends an applicability request for associated ID(s) to the UE, which may not contain any configuration. In response, the UE reports its associated ID(s) to the gNB.

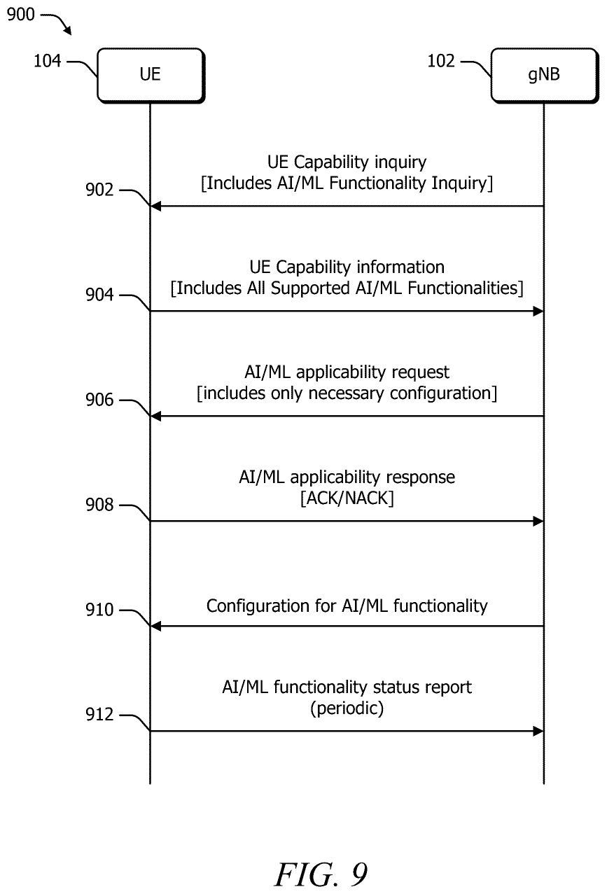

FIG. 9 is an example illustration of a signal flow diagram 900 for reporting of AI/ML functionality status in accordance with aspects of the present disclosure. The signal flow diagram 900 includes a UE 104 and a NE 102, such as a gNB. At 902, the gNB 102 can send a UE capability inquiry that can include an AI/ML functionality inquiry. At 904, the UE 104 can send UE capability information that can include at least some or all supported AI/ML functionalities. At 906, the gNB 102 can send an AI/ML applicability request, which may include only the necessary configuration or may include additional configuration(s). At 908, the UE 104 can send an AI/ML applicability response that can include an ACK/NACK. At 910, the gNB can send a configuration for AI/ML functionality. At 912, the UE 104 can send an AI/ML functionality status report that may be periodic.

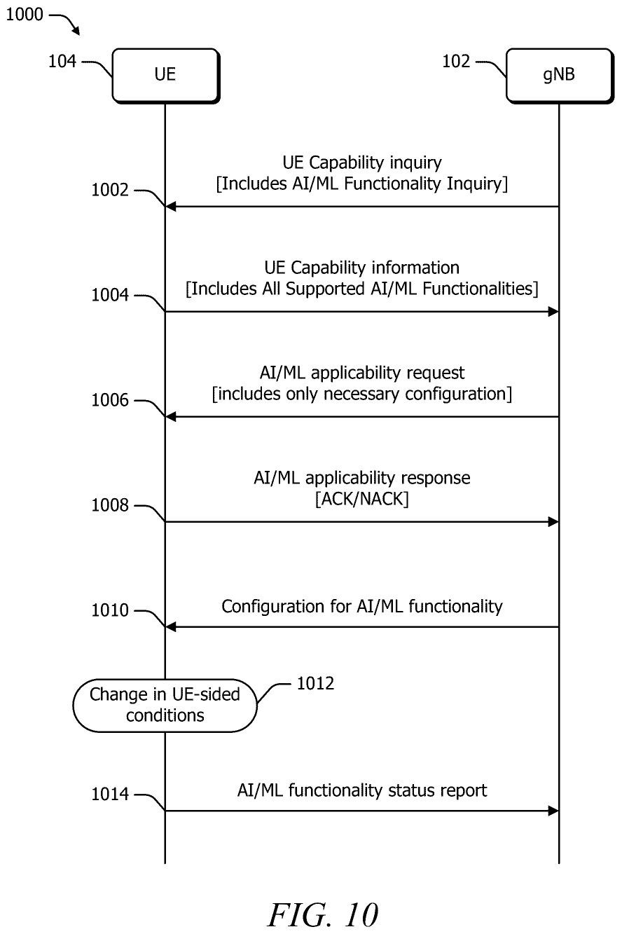

FIG. 10 is an example illustration of a signal flow diagram 1000 for reporting of AI/ML functionality status in accordance with aspects of the present disclosure. The signal flow diagram 1000 includes a UE 104 and a NE 102, such as a gNB. At 1002, the gNB 102 can send a UE capability inquiry that can include an AI/ML functionality inquiry. At 1004, the UE 104 can send UE capability information that can include at least some or all supported AI/ML functionalities. At 1006, the gNB 102 can send an AI/ML applicability request, which may include only the necessary configuration or may include additional configuration(s). At 1008, the UE 104 can send an AI/ML applicability response that can include an ACK/NACK. At 1010, the gNB can send a configuration for AI/ML functionality. At 1012, there can be a change in UE-sided conditions and the UE 104 can detect the change in UE-sided conditions. At 1014, the UE can send an AI/ML functionality status report, such as in response to detecting the change in UE-sided conditions.

For example, a node, e.g., UE transmits the current/updated status (for e.g., ACK/NACK) of its supported and applicable AI/ML functionality/model which it reported as its capability (UE capability framework) to a second node, e.g., gNB. In one implementation, the UE can be configured by the gNB to report its AI/ML functionality status periodically after the applicability for a specific AI/ML functionality is acknowledged by the UE, as illustrated in the signal flow diagram 900. In another implementation, the UE can be configured by the gNB to report its status in an event-triggered manner, for example, upon any change in the UE-side conditions or any change in the AI/ML model/functionality support, as illustrated in the signal flow diagram 1000. In another alternate implementation, the UE triggers the transmission of its status about its supported and applicable AI/ML functionality, upon any change in the UE-side conditions or any change in the AI/ML model/functionality support. For example, the UE can report its AI/ML status as not applicable for specific functionality such as beam management if a relevant AI/ML model cannot be activated/applied under current UE battery conditions or updated UE-side conditions due to mobility.

The status report can include an ACK/NACK indicating the applicability of a functionality. Alternatively, the status report can include additional assistance information such as selected configuration (when more than one configuration is provided by the NW) along with ACK/NACK for a functionality. This additional information can help the NW in its functionality management decision (reconfigure, fallback, switching), it may trigger a new applicability request or send an alternate configuration.

In one implementation, new RRC signaling can be used by the UE to report the UE status for a specific AI/ML functionality, if configured by the NW either with periodic reporting or event-triggered reporting.

In another implementation, the AI/ML functionality report can be sent using an UEAssistanceInformation (UAI) framework. The AIML-Assistance IE can be extended to include the status reports for different AI/ML features, such as beamManagementAIML-status, positioningAIML-status, etc. The reporting using UAI can enable the flexibility for the UE to transmit its AI/ML functionality status depending on its condition change or any model change/update. Further, this IE can also contain parameters describing UE-side additional conditions relevant for AI/ML functionalities, for instance, using the UEAdditionalConditions-r19 IE.

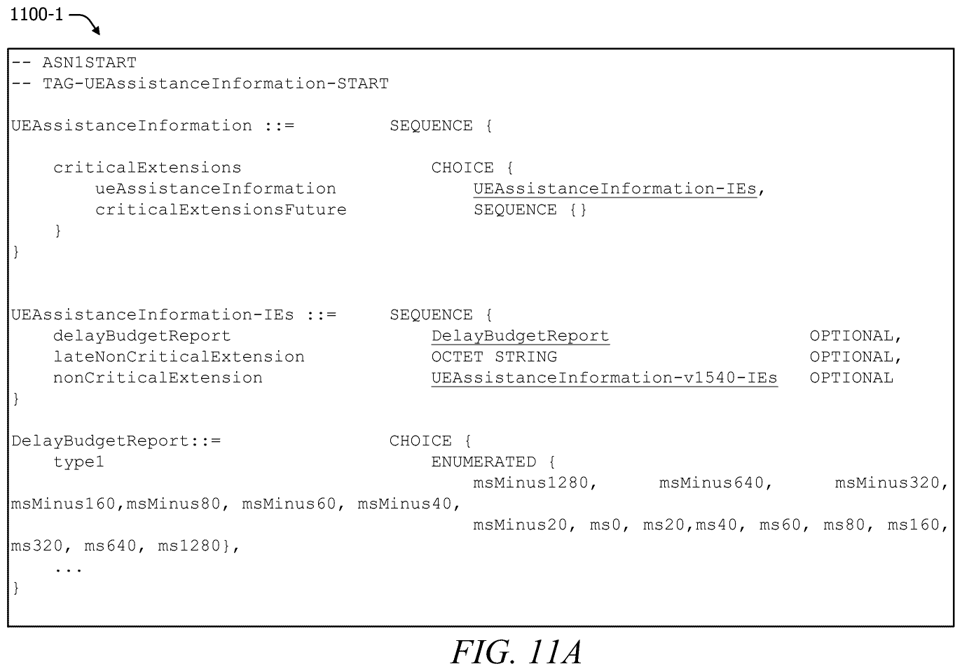

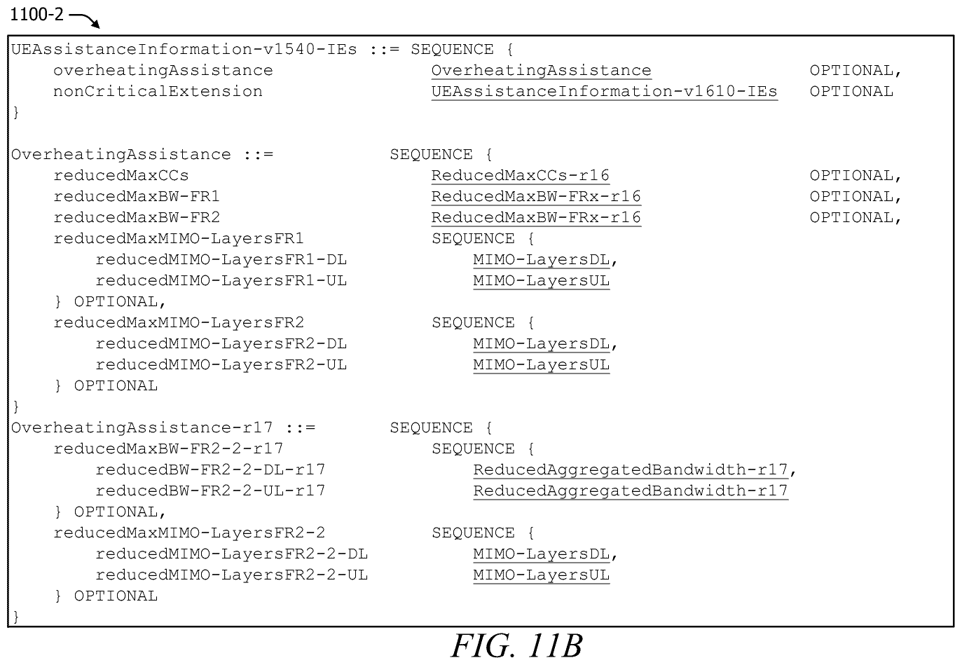

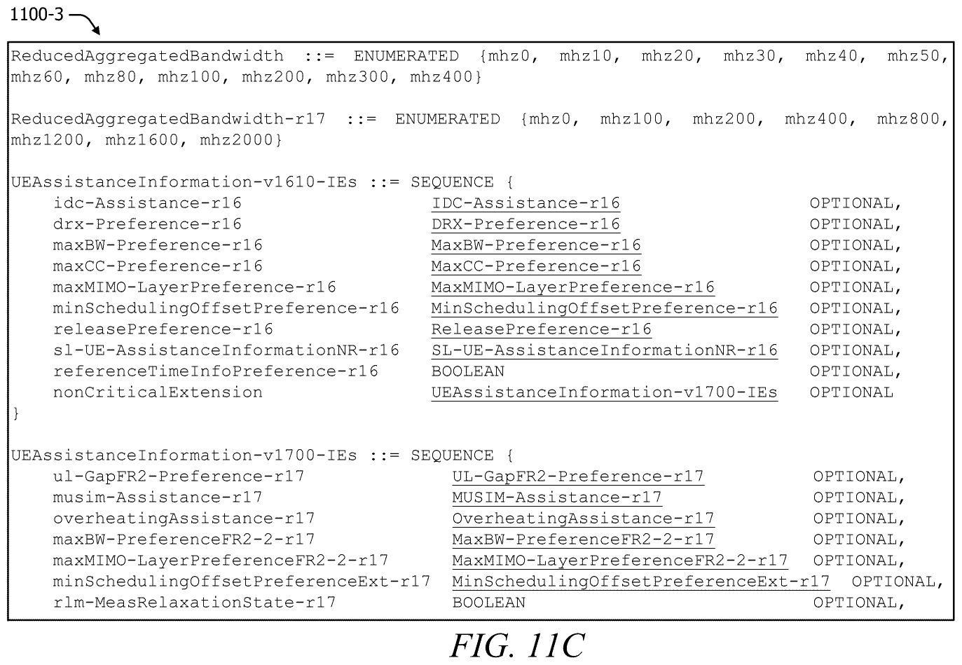

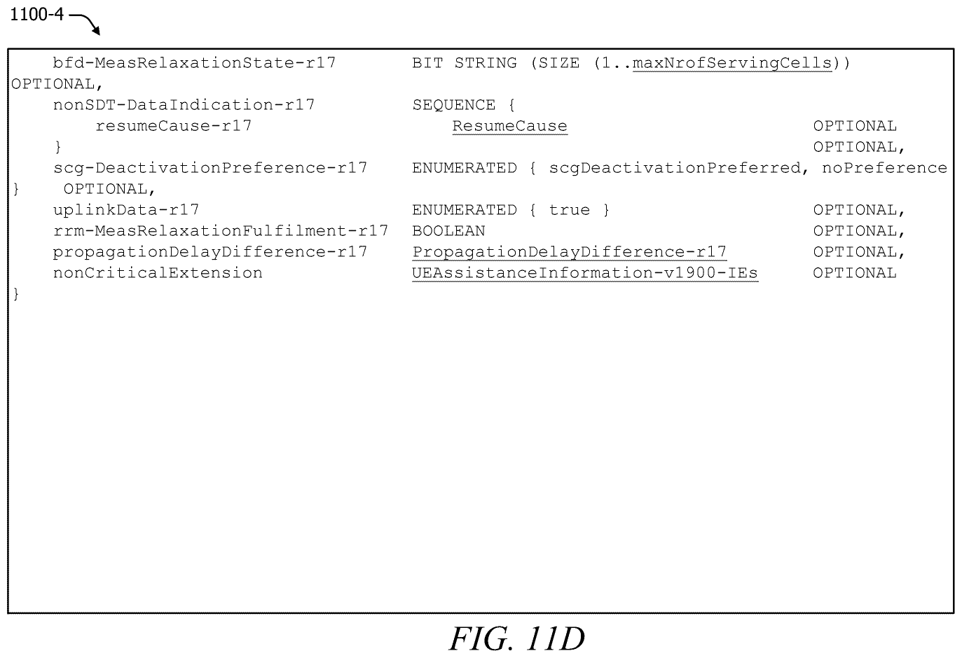

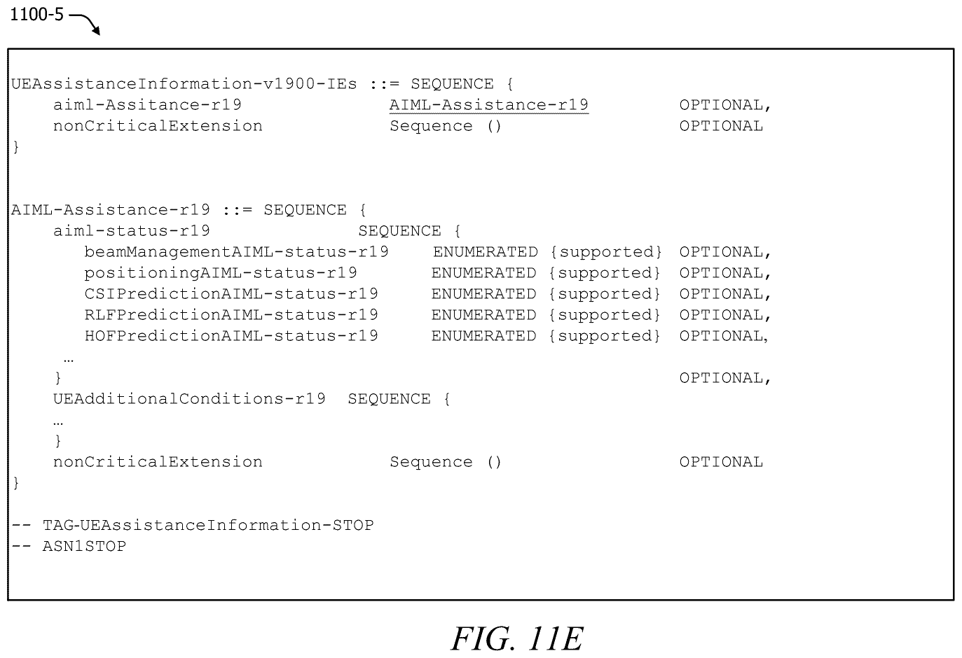

FIGS. 11A-11E are example illustrations of a UEAssistanceInformation IE 1100 in accordance with aspects of the present disclosure. The UEAssistanceInformation IE 1100 is shown in sequential sections 1100-1 through 1100-5. Section 1100-5 shows additional parameters of AIML-AssistanceInformation.

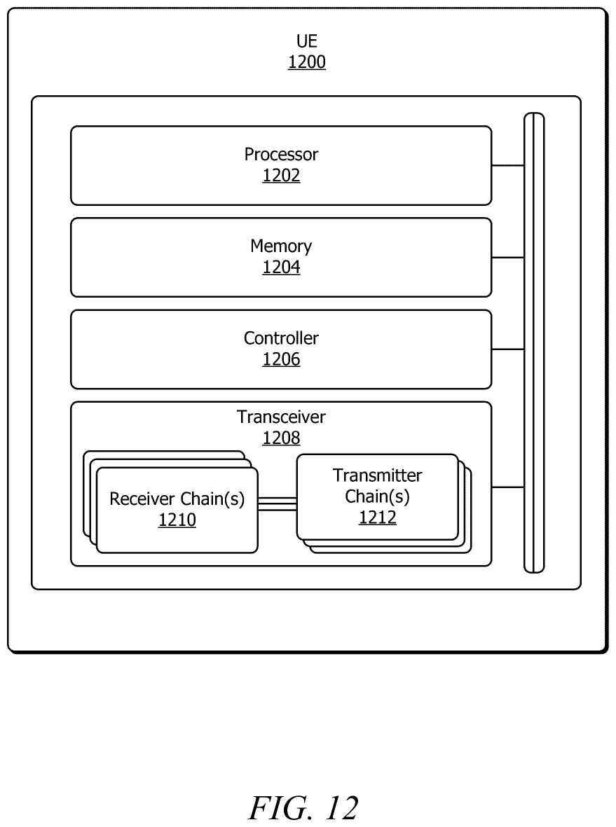

FIG. 12 illustrates an example of a UE 1200 in accordance with aspects of the present disclosure. The UE 1200 may include at least one processor 1202, at least one memory 1204, at least one controller 1206, and at least one transceiver 1208. The processor 1202, the memory 1204, the controller 1206, the transceiver 1208, various combinations thereof, or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202, cause the UE 1200 to perform various functions described herein. The code may be stored in a non-transitory computer-readable medium such as the memory 1204 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may also represent and/or include one or more other wireless and or wired communication interfaces, such as a NW interface, a universal serial bus (USB) port, an optical transceiver, and/or any other transceiver, interface, port, communication interface, etc. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding the processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more modulation techniques such as amplitude modulation (AM), frequency modulation (FM), digital modulation schemes like phase-shift keying (PSK) or quadrature amplitude modulation (QAM), and/or any other modulation techniques. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with the examples as disclosed herein.

The UE 1200 may be configured to support an apparatus and method for signaling AI/ML functionality. In operation according to a possible embodiment, the at least one processor 1202 is configured to cause the UE 1200 to receive a downlink message, the downlink message can include an AI IE; transmit, in response to receiving the AI IE, an indication of supported AI functionalities; receive a request message including at least one configuration relevant to at least one of the supported AI functionalities; determine whether an applicable AI functionality is applicable (AI/ML model exists) for the received at least one configuration; and transmit, based on the determining, a response message indicating the applicable AI functionality.

AI can include ML. Thus, the AI information element can be an AI/ML information element. The AI functionalities can include AI functionalities and/or models, such as one or more models for a functionality. Determining whether an applicable AI functionality exists can include determining whether an applicable AI model exists for the functionality, whether an applicable AI model exists for the functionality relevant to the requesting gNB, and/or can be based on at least one configuration for other reasons. The response message can indicate AI functionalities supported by the UE.

In a possible implementation, the response message can be transmitted via RRC, MAC-CE, or another transmission method, such as a transmission method that is typically the same as the method used for the request message. In a possible implementation, there can be one or more configurations for each supported AI functionality. There can also be multiple supported AI functionalities. There may or may not be at least one configuration for each supported AI functionality. For example, a configuration for a particular functionality may not have been provided.

In a possible implementation, any of the received configurations can be partial, such as necessary configurations, or complete configurations for an AI functionality. Also, an AI model for a received configuration of a functionality may not be available at the UE despite supporting the AI functionality. For example, a UE may generally support an AI functionality, but may not support the AI functionality with or for a particular configuration.

In a possible implementation, different functionality can be for different use cases, such as beam management, CSI prediction, RRM measurement prediction, radio link failure prediction, handover failure prediction, positioning, etc. There can be different models trained for the particular functionality, such as for different gNBs, different configurations, different scenarios, etc. For example, a configuration can be relevant radio parameters depending on the use case. In a possible example, the gNB can provide the set of beams to help the UE to pick a suitable model for beam management.

In a possible implementation, the downlink message contains a UE AI capability inquiry. For example, the downlink message can be the UE capability inquiry. The AI IE can be in the UE capability inquiry.

In a possible implementation, the at least one processor 1202 is configured to cause the UE 1200 to receive at least a partial configuration for the applicable AI functionality and/or activation of a previously reported configuration of the applicable AI functionality. In a possible example, this receiving can be in response to transmitting the response message.

In a possible implementation, applicability of the supported AI functionality depends on the configuration received in the request message. In a possible implementation, the response message contains either an acknowledgment (ACK) or a negative acknowledgment (NACK) for the applicable AI functionality. In a possible implementation, the configuration for functionality is used for AI inference.

In operation according to a possible embodiment, the at least one processor 1202 is configured to cause the UE 1200 to receive a first request message for capability information associated with AI; transmit a first response message comprising the capability information in response to the received first request message, wherein the capability information indicates one or more AI functionalities supported by the UE 1200; receive a second request message based at least in part on the transmitted first response message, wherein the second request message includes at least one configuration for AI; and transmit a second response message in response to the received second request message, wherein the second response message comprises feedback that indicates whether the at least one AI functionality supported by the UE 1200 is applicable for the at least one configuration.

In a possible implementation, the first request message contains a UE AI capability inquiry. In a possible implementation, the at least one processor 1202 is configured to cause the UE 1200 to receive at least a subset of the at least one configuration for the at least one AI functionality supported by the UE, or an indication to activate at least one second configuration for the at least one AI functionality supported by the UE. In a possible implementation, the at least one processor 1202 is configured to cause the UE 1200 to determine whether the at least one configuration is applicable for the at least one AI functionality supported by the UE 1200 based at least in part on one or more parameters of the at least one configuration. In a possible implementation, the feedback can be an acknowledgment (ACK) or a negative acknowledgment (NACK). In a possible implementation, the at least one processor 1202 is configured to cause the UE 1200 to use the configuration for functionality for AI inference. In a possible implementation, the at least one processor 1202 is configured to cause the UE 1200 to receive the first request message from a network entity, wherein the network entity comprises a base station or a network function of a core network. In a possible implementation, the first request message comprises an AI IE.

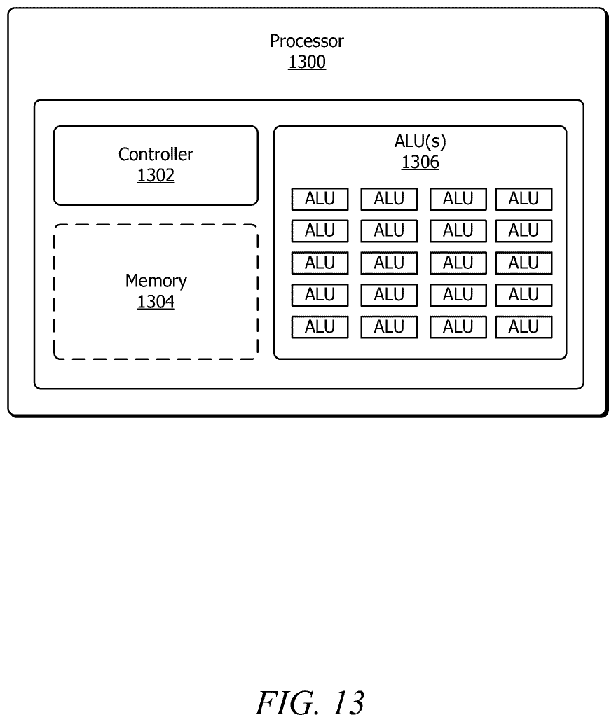

FIG. 13 illustrates an example of a processor 1300 in accordance with aspects of the present disclosure. The processor 1300 may be an example of a processor configured to perform various operations in accordance with the examples described herein. The processor 1300 may include at least one controller 1302 configured to perform various operations in accordance with the examples described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300)) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating the timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage the flow of data within the processor 1300. The controller 1302 may be configured to control the transfer of data between registers, ALUs, and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support an apparatus and method for signaling AI/ML functionality.

In operation according to a possible embodiment, the at least one controller 1302 is configured to cause the processor 1300 to: receive a downlink message that can include an AI IE; transmit, in response to receiving the AI IE, an indication of supported AI functionalities; receive a request message including at least one configuration relevant to at least one of the supported AI functionalities; determine whether an applicable AI functionality exists for the received at least one configuration; and transmit, based on the determining, a response message indicating the applicable AI functionality. In a possible implementation, the downlink message contains a UE AI capability inquiry. The processor 1300 can also perform at least some or all of the operations described with respect to the UE 1200.

In operation according to a possible embodiment, the at least one controller 1302 is configured to cause the processor 1300 to: receive a first request message for capability information associated with AI; transmit a first response message comprising the capability information in response to the received first request message, wherein the capability information indicates one or more AI functionalities supported by a UE; receive a second request message based at least in part on the transmitted first response message, wherein the second request message includes at least one configuration for AI; and transmit a second response message in response to the received second request message, wherein the second response message comprises feedback that indicates whether the at least one AI functionality supported by the UE is applicable for the at least one configuration.

In a possible implementation, the first request message contains a UE AI capability inquiry. In a possible implementation, the at least one controller 1302 is configured to cause the processor 1300 to receive at least a subset of the at least one configuration for the at least one AI functionality supported by the UE, or an indication to activate at least one second configuration for the at least one AI functionality supported by the UE.

In a possible implementation, the at least one controller 1302 is configured to cause the processor 1300 to determine whether the at least one configuration is applicable for the at least one AI functionality supported by the UE based at least in part on one or more parameters of the at least one configuration. In a possible implementation, the feedback comprises an acknowledgment (ACK) or a negative acknowledgment (NACK).

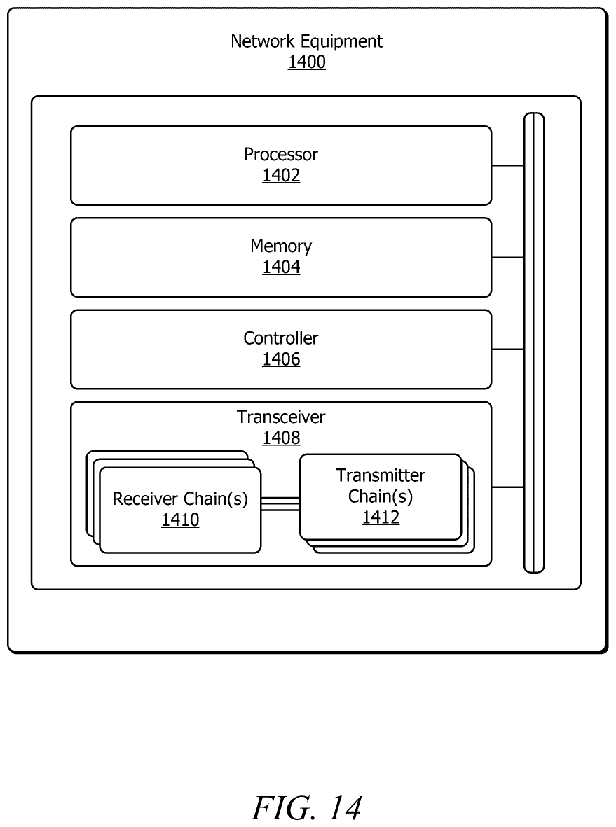

FIG. 14 illustrates an example of an NE 1400, such as a base station, in accordance with aspects of the present disclosure. The NE 1400 may include at least one processor 1402, at least one memory 1404, at least one controller 1406, and at least one transceiver 1408. The processor 1402, the memory 1404, the controller 1406, the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402, cause the NE 1400 to perform various functions described herein. The code may be stored in a non-transitory computer-readable medium such the memory 1404 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent at least one wireless transceiver and may include other transceivers, such as a wired transceiver, like a NW interface. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a LNA) configured to amplify the received signal. The receiver chain 1410 may include at least one demodulator configured to demodulate the received signal and obtain the transmitted data by reversing the modulation technique applied during the transmission of the signal. The receiver chain 1410 may include at least one decoder for decoding the processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more modulation techniques such as AM, FM, or digital modulation schemes like PSK or QAM, and/or any other modulation techniques. The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein.

The NE 1400 may be configured to support an apparatus and method for signaling AI/ML functionality. In operation according to a possible embodiment, the at least one processor 1402 can be configured to cause the NE 1400 to: transmit a downlink message containing an AI IE; receive, in response to the downlink message, a response indicating supported AI functionalities; transmit a request message that inquires about at least one configuration of at least one supported AI functionality; and receive an AI applicability response message in response to transmitting the request message, where the AI applicability response message can indicate at least one applicable AI functionality for the at least one configuration.

In a possible example, the supported AI functionalities can be AI functionalities supported by a UE. In a possible example, the downlink message can be a request message. The AI IE can request UE AI capability information of supported AI functionalities. The response message can be received from the UE. The UE configuration can be a UE AI configuration that configures, such as reconfigures and/or deconfigures, AI functionality of the UE.

In a possible implementation, the at least one processor is configured to cause the NE 1400 to send an AI functionality configuration including at least a partial configuration for the at least one applicable AI functionality and/or an activation of a previously reported configuration of the at least one applicable AI functionality. In a possible example, the AI functionality configuration can be a UE configuration for AI functionality.

In a possible implementation, the AI functionality configuration reconfigures the applicable AI functionality. In a possible example, configuring the applicable AI functionality can include reconfiguring and/or deconfiguring the functionality of a UE. The AI functionality configuration can also (re)configure an applicable AI functionality if the functionality is not present

In a possible implementation, the AI functionality configuration configures or reconfigures AI functionality if an applicable AI functionality cannot be activated. For example, the AI functionality configuration can configure the UE for the AI functionality if the applicable AI functionality cannot be activated.

In a possible implementation, the at least one configuration of the at least one supported AI functionality is used by a UE to determine the applicability of an AI functionality. In a possible example, the at least one configuration of at least one AI functionality can be required for the UE to determine the applicability.

In a possible implementation, the AI IE contains parameters relevant to at least one AI use case, where the at least one AI use case includes at least one use of AI functionality. The NE 1400 can also perform reciprocal operations to at least some or all of the operations performed by the UE 1200.

In operation according to a possible embodiment, the at least one processor 1402 can be configured to cause the NE 1400 to: transmit a first request message for capability information associated with AI; receive a first response message comprising the capability information in response to the received first request message, wherein the capability information indicates one or more AI functionalities supported by a UE; transmit a second request message based at least in part on the transmitted first response message, wherein the second request message includes at least one configuration for AI; and receive a second response message in response to the received second request message, wherein the second response message comprises feedback that indicates whether the at least one AI functionality supported by the UE is applicable for the at least one configuration.

In a possible implementation, the first request message contains a UE AI capability inquiry. In a possible implementation, the at least one processor 1402 is configured to cause the NE 1400 to transmit at least a subset of the at least one configuration for the at least one AI functionality supported by the UE, or an indication to activate at least one second configuration for the at least one AI functionality supported by the UE. In a possible implementation, the first request message comprises an AI IE.

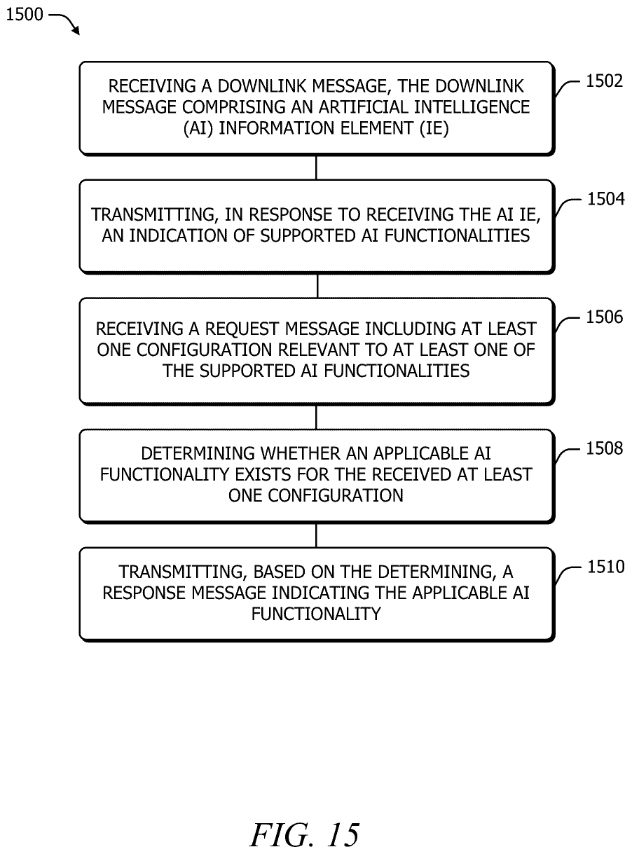

FIG. 15 illustrates a flowchart 1500 of a method in accordance with aspects of the present disclosure. The operations of the method may be implemented by a UE as described herein. In some implementations, the UE may execute a set of instructions to control the function elements of the UE to perform the described functions. Each operation of the flowchart 1500 may be performed in accordance with the examples described herein. In some implementations, aspects of particular operations may be performed by a UE 1200 as described with reference to FIG. 12.

At 1502, the method can include receiving a downlink message, the downlink message can include an AI IE. At 1504, the method can include transmitting, in response to receiving the AI IE, an indication of supported AI functionalities. At 1506, the method can include receiving a request message including at least one configuration relevant to at least one of the supported AI functionalities. At 1508, the method can include determining whether an applicable AI functionality exists for the received at least one configuration. At 1510, the method can include transmitting, based on the determining, a response message indicating the applicable AI functionality.

In a possible implementation, the downlink message contains a UE AI capability inquiry. In a possible implementation, the method can include receiving at least a partial configuration for the applicable AI functionality and/or activation of a previously reported configuration of the applicable AI functionality. In a possible implementation, applicability of the supported AI functionality depends on the configuration received in the request message. In a possible implementation, the response message contains either an acknowledgment (ACK) or a negative acknowledgment (NACK) for the applicable AI functionality. In a possible implementation, the configuration for functionality is used for AI inference. The method may also include at least some or all of the other operations performed by the UE 1200.

It should be noted that the method described herein describes a possible embodiment, and that the operations and the steps may be rearranged or otherwise modified and that other embodiments are possible.

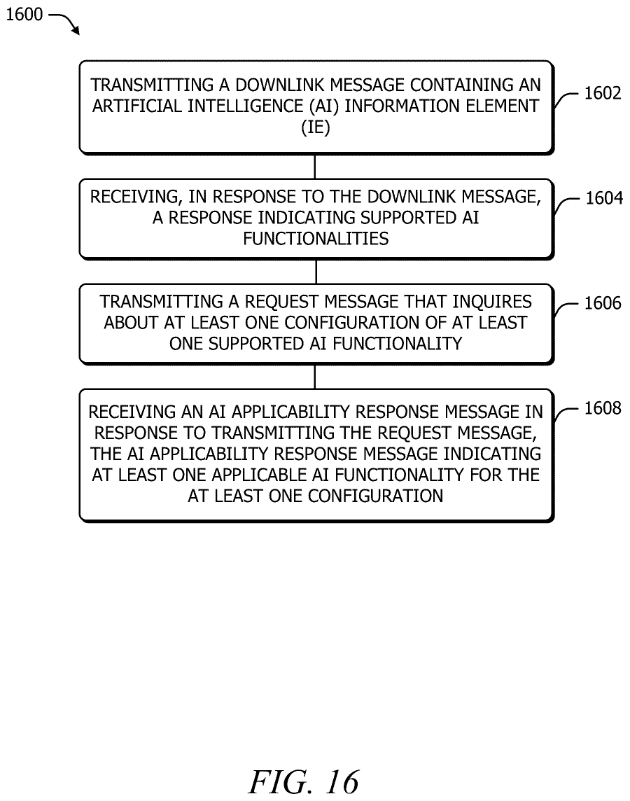

FIG. 16 illustrates a flowchart 1600 of a method in accordance with aspects of the present disclosure. The operations of the method may be implemented by a NE as described herein. In some implementations, the NE may execute a set of instructions to control the function elements of the NE to perform the described functions. Each operation of the flowchart 1600 may be performed in accordance with the examples described herein. In some implementations, aspects of particular operations may be performed by the NE 1400 as described with reference to FIG. 14.

At 1602, the method can include transmitting a downlink message containing an AI IE. At 1604, the method can include receiving, in response to the downlink message, a response indicating supported AI functionalities. At 1606, the method can include transmitting a request message that inquires about at least one configuration of at least one supported AI functionality. At 1608, the method can include receiving an AI applicability response message in response to transmitting the request message, the AI applicability response message indicating at least one applicable AI functionality for the at least one configuration.

In a possible implementation, the supported AI functionalities can be AI functionalities supported by a UE. In a possible implementation, the downlink message can be a request message. The AI IE can request UE AI capability information of supported AI functionalities. The response message can be received from the UE. The UE configuration can be a UE AI configuration that configures, such as reconfigures and/or deconfigures, AI functionality of the UE.

In a possible implementation, the method can include sending an AI functionality configuration that can include at least a partial configuration for the at least one applicable AI functionality and/or an activation of a previously reported configuration of the at least one applicable AI functionality. The AI functionality configuration can be a UE configuration for AI functionality.

In a possible implementation, the AI functionality configuration reconfigures the applicable AI functionality. Configuring the applicable AI functionality can include reconfiguring and/or deconfiguring the functionality of a UE. It can also (re)configure an applicable AI functionality if the functionality is not present.

In a possible implementation, the AI functionality configuration configures or reconfigures AI functionality if an applicable AI functionality cannot be activated. For example, the AI functionality configuration can configure the UE for the AI functionality if the applicable AI functionality cannot be activated.

In a possible implementation, the at least one configuration of the at least one supported AI functionality is used by a UE to determine the applicability of an AI functionality. In a possible example, the at least one configuration of at least one AI functionality can be required for the UE to determine the applicability.

In a possible implementation, the AI IE contains parameters relevant to at least one AI use case, where the at least one AI use case can include at least one use of AI functionality. The method may also include at least some or all of the other operations performed by the NE 1400.

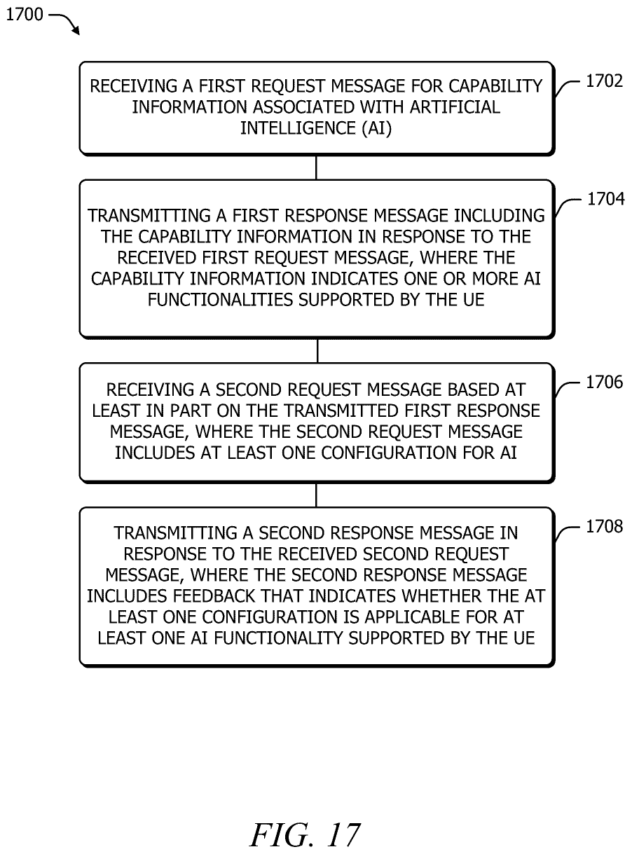

FIG. 17 illustrates a flowchart 1700 of a method in accordance with aspects of the present disclosure. The operations of the method may be implemented by a UE as described herein. In some implementations, the UE may execute a set of instructions to control the function elements of the UE to perform the described functions. Each operation of the flowchart 1700 may be performed in accordance with the examples described herein. In some implementations, aspects of particular operations may be performed by a UE 1200 as described with reference to FIG. 12.

At 1702, the method can include receiving a first request message for capability information associated with AI. At 1704, the method can include transmitting a first response message including the capability information in response to the received first request message, where the capability information indicates one or more AI functionalities supported by the UE. At 1706, the method can include receiving a second request message based at least in part on the transmitted first response message, where the second request message includes at least one configuration for AI. At 1708, the method can include transmitting a second response message in response to the received second request message, where the second response message includes feedback that indicates whether the at least one AI functionality supported by the UE is applicable for the at least one configuration.

In a possible implementation, the first request message contains a UE AI capability inquiry. In a possible implementation, the method can include receiving at least a subset of the at least one configuration for the at least one AI functionality supported by the UE, or an indication to activate at least one second configuration for the at least one AI functionality supported by the UE.

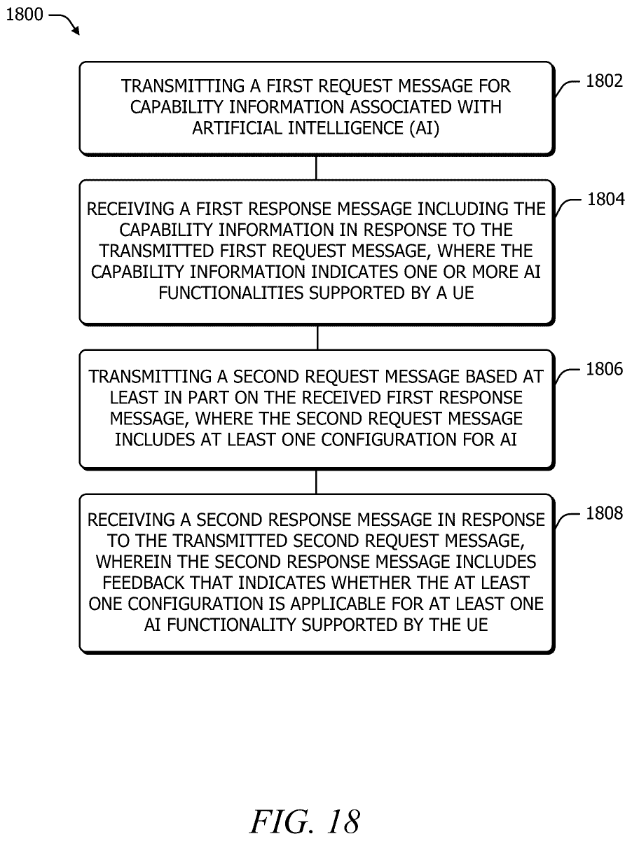

FIG. 18 illustrates a flowchart 1800 of a method in accordance with aspects of the present disclosure. The operations of the method may be implemented by a NE as described herein. In some implementations, the NE may execute a set of instructions to control the function elements of the NE to perform the described functions. Each operation of the flowchart 1800 may be performed in accordance with the examples described herein. In some implementations, aspects of particular operations may be performed by the NE 1400 as described with reference to FIG. 14.

At 1802, the method can include transmitting a first request message for capability information associated with AI. At 1804, the method can include receiving a first response message including the capability information in response to the transmitted first request message, where the capability information indicates one or more AI functionalities supported by a UE. At 1806, the method can include transmitting a second request message based at least in part on the received first response message, where the second request message includes at least one configuration for AI. At 1808, the method can include receiving a second response message in response to the transmitting second request message, where the second response message comprises feedback that indicates whether the at least one AI functionality supported by the UE is applicable for the at least one configuration.

At least some embodiments can provide for UE reporting of its AI/ML capability to NW. The UE capability framework can be extended to report the supported AI/ML functionalities by the UE. An AIML-Parameters IE can be used for UE capability. The IE can contain AI/ML-relevant parameters such as indications of all the supported AI/ML functionalities. In response to a UECapabilityEnquiry, the UE can report some or all of its AI/ML functionalities via AIML-Parameters as capability information.

Embodiments can provide for an applicable AI/ML functionality framework. A handshake mechanism can be used to enable request/response of the applicability of a specific AI/ML functionality. The NW can send a request to the UE, AI/ML applicability request, to enquire about the applicability of the AI/ML functionality/model. The applicability request can contain only the necessary configuration or additional configuration that may be required to determine a suitable model for a specific AI/ML functionality. The UE can send a response, AI/ML applicability response, reassuring the support i.e., applicability of an AI/ML functionality. The UE can send an ACK if it has a suitable model for the gNB. The UE can send NACK if it does not have a suitable model for the gNB. The NW can configure the UE for the AI/ML functionality after receiving an acknowledgment. Otherwise, it may reconfigure/deconfigure the UE for this AI/ML functionality.

At least some embodiments can provide for reporting of AI/ML functionality status. A UE can report its status on AI/ML functionality to the NW. The NW may configure the UE to provide periodic or event-triggered status reports. The UE may trigger the status report. The AI/ML IE in the UAI can be extended.

A possible embodiment can provide a method in a UE. The method can include receiving a downlink message, wherein the message includes the AI/ML IE. The method can include transmitting an indication of supported AI/ML functionalities/models in UE capability information. The method can include receiving a request message, where the received message includes the configuration relevant to AI/ML functionalities. The method can include determining, in response to the reception of the request message, if an applicable AI/ML model exists. The method can include transmitting a response message, where the response message indicates the applicability of an AI/ML functionality. The method can include receiving a part or full configuration for the AI/ML functionality.

In a possible implementation, the downlink message contains UE capability inquiry. In a possible implementation, the applicability of AI/ML functionality/model depends on the configuration received in the request message. In a possible implementation, the response message contains either ACK/NACK for the AI/ML functionality. In a possible implementation, the configuration for functionality is used for AI/ML inference.

A possible embodiment can provide a method in a NW equipment. The method can include transmitting a request message (UE capability), where the message contains an AI/ML IE. The method can include receiving a response from the UE, where the supported AI/ML functionalities are indicated in the response. The method can include transmitting a request message to the UE inquiring about the applicability of supported AI/ML functionalities/models. The method can include transmitting a part/full configuration for AI/ML functionality, where the configuration can be required to determine the applicability of an AI/ML functionality. The method can include receiving a response message (AI/ML applicability) from the UE. The method can include configuring the UE in response to the response message (applicability).

In a possible implementation, the AI/ML IE contains parameters relevant to AI/ML use-cases. In a possible implementation, the NW reconfigures or deconfigures the UE if an applicable AI/ML model is not present or cannot be activated.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

At least some methods of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

At least some embodiments can improve operation of the disclosed devices. Various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

An article “a” before an element is unrestricted and understood to refer to “at least one” of those elements or “one or more” of those elements. The terms “a,” “at least one,” “one or more,” and “at least one of one or more” may be interchangeable. For example, an element proceeded by “a,” “an,” or the like does not, without more constraints, preclude the existence of additional identical elements in the process, method, article, or apparatus that comprises the element. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). For example, the phrase “at least one of,” “at least one selected from the group of,” or “at least one selected from” followed by a list is defined to mean one, some, or all, but not necessarily all of, the elements in the list. Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, the term “another” is defined as at least a second or more. The terms “including,” “having,” and the like, as used herein, are defined as “comprising.” Terms of approximation, such as “approximately,” “near,” “substantially,” and/or other related terms, unless otherwise defined, are defined as a range within +/−5% of the approximated element, a range within +/−10% of the approximated element, and/or a range close enough to the approximated element to achieve an intended result. All elements of the disclosed embodiments can be modified with such terms. In this document, relational terms such as “first,” “second,” and the like may be used solely to distinguish one entity or action from another entity or action without necessarily requiring or implying any actual such relationship or order between such entities or actions.

The background section is not admitted as prior art, is written as the inventor's own understanding of the context of some embodiments at the time of filing, and includes the inventor's own recognition of any problems with existing technologies and/or problems experienced in the inventor's own work.

The following abbreviations are defined for this disclosure: 3GPP: 3rd Generation Partnership Project; 5G: Fifth Generation; 5G-CRG: 5G-Cable Residential Gateway; 5G-GUTI: 5G-Global Unique Temporary Identifier; 5G-S-TMSI: 5G Short-Temporary Mobile Subscription Identifier; 5G-TMSI: 5G Temporary Mobile Subscription Identifier; ACK: Acknowledgement; A-CSI: Aperiodic CSI; AF: Application Function; AI: Artificial Intelligence; AMF: Access and Mobility Management Function; BFD: Beam Failure Detection; BWP: Bandwidth Part; CA: Carrier Aggregation; CC: Component Carrier; CCCH SDU: Common Control Channel Service Data Unit; CCE: Control Channel Element; CDMA: Code Division Multiple Access; CM: Connection Management; CORESET: Control Resource Set; CRC: Cyclic Redundancy Check; CRI: CSI-RS Resource Index; C-RNTI: Cell RNTI; CSI-RS: Channel State Information Reference Signal; CSI: Channel State Information; CSS: Common Search Space; D2D: Device-to-Device; DCI: Downlink Control Information; DL: Downlink; DMRS: Demodulation Reference Signal; DRX: Discontinuous Reception; E-UTRAN: Evolved Universal Terrestrial Access Network; eNB: Enhanced NodeB; FDD: Frequency Division Duplex; FN-BRG: Fixed Network Broadband RG; FN-CRG: Fixed Network Cable RG; GCI: Global Cable identifier; GERAN: GSM EDGE Radio Access Network; GLI: Global Line Identifier; gNB: New Radio NodeB; GPSI: Generic Public Subscription Identifier; GUAMI: Global Unique AMF Identifier; GUE: Gateway UE; GUTI: Global Unique Temporary Identifier; HARQ-ACK: Hybrid Automatic Repeat Request-Acknowledgement; HST: High Speed Train; ID: Identifier; IE: Information Element; IIoT: Industrial Internet of Things; IMEI: International Mobile Equipment Identity; IMEISV: International Mobile Equipment Identity Software Version; IMSI: International Mobile Subscriber Identity; IoT: Internet of Things; I-RNTI: Inactive Radio Network Temporary Identifier; LTE: Long Term Evolution; MAC: Medium Access Control; MAC CE: Medium Access Control Control Element; MCG: Master Cell Group; MCS: Modulation and Coding Scheme; ML: Machine Learning; MPE: Maximum Permissible Exposure; MPO: MsgA PUSCH Occasion; MsgA: Message A; MsgB: Message B; MTC: Machine Type Communication; NACK: Non-Acknowledgement; NE: Network Element; NEF: Network Exposure Function; NG-RAN: Next-Generation Radio Access Network; NR: New Radio; NUL: Non-supplementary Uplink; OAM: Operations, Administration and Maintenance; OFDMA: Orthogonal Frequency Division Multiple Access; PCell: Primary Cell; PDCCH: Physical Downlink Control Channel; PDSCH: Physical Downlink Shared Channel; PDU: Protocol Data Unit; PEI: Permanent Equipment Identifier; PF: Paging Frame; PHR: Power Headroom Report; MPE-P-MPR: Maximum Permitted Exposure Power Management Maximum Power Reduction; P-MPR: Power Management Maximum Power Reduction; PO: Paging Occasion; PRACH: Physical Random Access Channel; PSCell: Primary Secondary Cell; PS-RNTI: Power Saving RNTI; PUCCH: Physical Uplink Control Channel; PUSCH: Physical Uplink Shared Channel; QCL: Quasi-co-location; RACH: Random Access Channel (Procedure); RAN: Radio Access Network; RAR: Random Access Response; RG: Residential Gateway; RLF: Radio Link Failure; RLM: Radio Link Monitoring; RM: Registration Management; RNA: RAN-based Notification Area; RNTI: Radio Network Temporary Identifier; RRC: Radio Resource Control; RRM: Radio Resource Management; RS: Reference Signal; RSRP: Reference Signal Received Power; RUE: Real UE (non-virtual UE); SAR: Specific Absorption Rate; SCell: Secondary Cell; SCG: Secondary Cell Group; SCS: Subcarrier Spacing; SFI: Slot Format Indicator; SFN: Single Frequency Network; S-NSSAI: Single Network Slice Selection Assistance Information; SpCell: Special Cell (i.e. a PCell of a MCG or SCG); SP-CSI: Semi-persistent CSI; SR: Scheduling Request; SRI: SRS Resource Indicator; SRS: Sounding Reference Signal; SPS: Semi-persistent scheduling; SS: Search space; SS/PBCH: Synchronization Signal/Physical Broadcast Channel; SSBRI: SS/PBCH Block Resource Index; SUL: Supplementary Uplink; SUPI: Subscription Permanent Identifier; TB: Transport block; TCI: Transmission Configuration Indicator; TC-RNTI: Temporary Cell RNTI; TDD: Time Division Duplex; TDMA: Time Division Multiple Access; TMSI: Temporary Mobile Subscriber Identity; TPC: Transmit Power Control; TRP: Transmission and Reception Point; UCI: Uplink Control Information; UDM: Unified Data Management; UDR: Unified Data Repository; UE: User Equipment; UL: Uplink; UPF: User Plane Function; URLLC: Ultra-Reliable Low-Latency Communication; USS: UE-specific Search Space; VUE: Virtual UE; W-5GAN: Wireline 5G Access Network; XR: eXtended Reality

What is claimed is:

1. A user equipment (UE) for wireless communication, comprising:
at least one memory; and
at least one processor coupled with the at least one memory and configured to cause the UE to:
receive a first request message for capability information associated with artificial intelligence (AI);
transmit a first response message comprising the capability information in response to the received first request message, wherein the capability information indicates one or more AI functionalities supported by the UE;
receive a second request message based at least in part on the transmitted first response message, wherein the second request message includes at least one configuration for AI; and
transmit a second response message in response to the received second request message, wherein the second response message comprises feedback that indicates whether the at least one AI functionality supported by the UE is applicable for the at least one configuration.

2. The UE of claim 1, wherein the first request message contains a UE AI capability inquiry.

3. The UE of claim 1, wherein the at least one processor is configured to cause the UE to receive at least a subset of the at least one configuration for the at least one AI functionality supported by the UE, or an indication to activate at least one second configuration for the at least one AI functionality supported by the UE.

4. The UE of claim 1, wherein the at least one processor is configured to cause the UE to determine whether the at least one configuration is applicable for the at least one AI functionality supported by the UE based at least in part on one or more parameters of the at least one configuration.

5. The UE of claim 1, wherein the feedback comprises an acknowledgment (ACK) or a negative acknowledgment (NACK).

6. The UE of claim 1, wherein the at least one processor is configured to cause the UE to use the configuration for functionality for AI inference.

7. The UE of claim 1, wherein the at least one processor is configured to cause the UE to receive the first request message from a network entity, wherein the network entity comprises a base station or a network function of a core network.

8. The UE of claim 1, wherein the first request message comprises an AI information element (IE).

9. A base station for wireless communication, comprising:
at least one memory; and
at least one processor coupled with the at least one memory and configured to cause the base station to:
transmit a first request message for capability information associated with artificial intelligence (AI);
receive a first response message comprising the capability information in response to the received first request message, wherein the capability information indicates one or more AI functionalities supported by a user equipment (UE);
transmit a second request message based at least in part on the transmitted first response message, wherein the second request message includes at least one configuration for AI; and
receive a second response message in response to the received second request message, wherein the second response message comprises feedback that indicates whether the at least one configuration is applicable for at least one AI functionality supported by the UE.

10. The base station of claim 9, wherein the first request message contains a UE AI capability inquiry.

11. The base station of claim 9, wherein the at least one processor is configured to cause the base station to transmit at least a subset of the at least one configuration for the at least one AI functionality supported by the UE, or an indication to activate at least one second configuration for the at least one AI functionality supported by the UE.

12. The base station of claim 9, wherein the first request message comprises an AI information element (IE).

13. A processor for wireless communication, comprising:
at least one controller coupled with at least one memory and configured to cause the processor to:
receive a first request message for capability information associated with artificial intelligence (AI);
transmit a first response message comprising the capability information in response to the received first request message, wherein the capability information indicates one or more AI functionalities supported by a user equipment (UE);
receive a second request message based at least in part on the transmitted first response message, wherein the second request message includes at least one configuration for AI; and
transmit a second response message in response to the received second request message, wherein the second response message comprises feedback that indicates whether the at least one AI functionality supported by the UE is applicable for the at least one configuration.

14. The processor of claim 13, wherein the first request message contains a UE AI capability inquiry.

15. The processor of claim 13, wherein the at least one controller is configured to cause the processor to receive at least a subset of the at least one configuration for the at least one AI functionality supported by the UE, or an indication to activate at least one second configuration for the at least one AI functionality supported by the UE.

16. The processor of claim 13, wherein the at least one controller is configured to cause the processor to determine whether the at least one configuration is applicable for the at least one AI functionality supported by the UE based at least in part on one or more parameters of the at least one configuration.

17. The processor of claim 13, wherein the feedback comprises an acknowledgment (ACK) or a negative acknowledgment (NACK).

18. A method performed by a user equipment (UE), the method comprising:
receiving a first request message for capability information associated with artificial intelligence (AI);
transmitting a first response message comprising the capability information in response to the received first request message, wherein the capability information indicates one or more AI functionalities supported by the UE;
receiving a second request message based at least in part on the transmitted first response message, wherein the second request message includes at least one configuration for AI; and
transmitting a second response message in response to the received second request message, wherein the second response message comprises feedback that indicates whether the at least one AI functionality supported by the UE is applicable for the at least one configuration.

19. The method of claim 18, wherein the first request message contains a UE AI capability inquiry.

20. The method of claim 18, further comprising receiving at least a subset of the at least one configuration for the at least one AI functionality supported by the UE, or an indication to activate at least one second configuration for the at least one AI functionality supported by the UE.
